(19) United States
(12) Patent Application Publication
(10) Pub. No.: US 2026/0061746 A1
(43) Pub. Date: Mar. 5, 2026

(54) LIQUID EJECTING APPARATUS AND LIQUID EJECTING HEAD

(71) Applicant: SEIKO EPSON CORPORATION, Tokyo (JP)

(72) Inventor: Osamu SHINKAWA, Chino (JP)

(21) Appl. No.: 19/313,922

(22) Filed: Aug. 29, 2025

(30) Foreign Application Priority Data
Sep. 2, 2024 (JP) 2024-150434

(51) Int. Cl. B41J 2/14; B41J 2/045

(52) U.S. Cl. CPC B41J 2/14201; B41J 2/04581; B41J 2/04588

(57) ABSTRACT

An ink jet printer includes: a drive signal generation unit that generates a drive signal, an ejecting section that includes a nozzle, a piezoelectric element driven by the drive signal, and a cavity that ejects an ink from the nozzle in response to driving of the piezoelectric element, a first inspection signal generation circuit to which a residual vibration signal generated by residual vibration in the ejecting section after the piezoelectric element is driven is input and which generates a pseudo residual vibration signal according to the residual vibration signal, and an inspection unit that determines a state of the ejecting section based on the pseudo residual vibration signal, in which the first inspection signal generation circuit includes a first filter circuit that generates the pseudo residual vibration signal, and the first filter circuit includes a variable resistor element having an adjustable resistance value.

The present application is based on, and claims priority from JP Application Serial Number 2024-150434, filed Sep. 2, 2024, the disclosure of which is hereby incorporated by reference herein in its entirety.

### BACKGROUND

### 1. Technical Field

The present disclosure relates to a liquid ejecting apparatus and a liquid ejecting head.

### 2. Related Art

In a liquid ejecting apparatus such as an ink jet printer, in each of a plurality of unit periods defined by a latch signal, the liquid ejecting apparatus drives an ejecting section included in a liquid ejecting head to eject a liquid such as ink filled in the ejecting section to form an image on a medium. Meanwhile, in this type of liquid ejecting apparatus, an ejection abnormality in which the liquid cannot be normally ejected from the ejecting section may occur. Therefore, in the related art, a technique for inspecting an ejection state of an ejecting section is proposed. For example, JP-A-2020-044771 discloses a technique for inspecting an ejection state of an ejecting section based on a detection signal indicating residual vibration in the ejecting section after the ejecting section is driven by a drive signal.

Meanwhile, according to the technique in the related art, when inspecting the ejection state of the ejecting section, both the driving of the ejecting section by the drive signal and the detection of the residual vibration in the driven ejecting section are executed in a unit period which is a cycle for driving the ejecting section. Thus, the unit period needs to be set to have a sufficiently long time length.

### SUMMARY

According to an aspect of the present disclosure, there is provided a liquid ejecting apparatus including: a drive signal generation section that generates a drive signal; an ejecting section that includes a nozzle, a piezoelectric element driven by the drive signal, and a pressure chamber that ejects a liquid from the nozzle in response to driving of the piezoelectric element; a signal generation section to which a residual vibration signal generated by residual vibration in the ejecting section after the piezoelectric element is driven is input, and which generates a pseudo residual vibration signal according to the residual vibration signal; and a determination section that determines a state of the ejecting section based on the pseudo residual vibration signal, in which the signal generation section includes a filter circuit that generates the pseudo residual vibration signal, and the filter circuit includes a variable resistor section having an adjustable resistance value.

In addition, according to still another aspect of the present disclosure, there is provided a liquid ejecting head including: an ejecting section that includes a nozzle, a piezoelectric element driven by a drive signal, and a pressure chamber that ejects a liquid from the nozzle in response to driving of the piezoelectric element; and a signal generation section to which a residual vibration signal generated by residual vibration in the ejecting section after the piezoelectric element is driven is input, and which generates a pseudo residual vibration signal according to the residual vibration signal, as a signal for determining a state of the ejecting section, in which the signal generation section includes a filter circuit that generates the pseudo residual vibration signal, and the filter circuit includes a variable resistor section having an adjustable resistance value.

### BRIEF DESCRIPTION OF THE DRAWINGS

FIG. 1 is a block diagram illustrating an example of a configuration of an ink jet printer according to an embodiment of the present disclosure.

FIG. 2 is a perspective diagram illustrating an example of a schematic internal structure of the ink jet printer.

FIG. 3 is a cross-sectional diagram describing an example of a structure of an ejecting section.

FIG. 4 is an explanatory diagram describing an ejecting operation of an ink by the ejecting section.

FIG. 5 is a plan diagram illustrating an example of arrangement of nozzles in a head unit.

FIG. 6 is a block diagram illustrating an example of a configuration of the head unit.

FIG. 7 is a block diagram illustrating an example of a configuration of a detection circuit.

FIG. 8 is a circuit diagram illustrating an example of a configuration of a first selection circuit.

FIG. 9 is a circuit diagram illustrating an example of a configuration of a first inspection signal generation circuit.

FIG. 10 is a circuit diagram illustrating an example of a configuration of a variable resistor element.

FIG. 11 is a circuit diagram illustrating another example of the configuration of the variable resistor element.

FIG. 12 is a circuit diagram illustrating an example of a configuration of a variable capacitor.

FIG. 13 is a circuit diagram illustrating an example of a configuration of a second inspection signal generation circuit.

FIG. 14 is an explanatory diagram describing characteristics of a first filter circuit.

FIG. 15 is a diagram illustrating a simulation result of the first filter circuit.

FIG. 16 is an explanatory diagram describing an operation of a low-pass filter circuit when a first input signal is switched from a detection signal to a first reference potential.

FIG. 17 is an explanatory diagram describing effects of a first switching circuit and the low-pass filter circuit.

FIG. 18 is a timing chart illustrating an example of an operation of the ink jet printer during a unit period.

FIG. 19 is an explanatory diagram describing an example of a first inspection signal generated by the first inspection signal generation circuit.

FIG. 20 is an explanatory diagram describing an example of a second inspection signal generated by the second inspection signal generation circuit.

FIG. 21 is a block diagram illustrating an example of a configuration of a detection circuit according to a first modification example.

FIG. 22 is a circuit diagram illustrating an example of a configuration of a third filter circuit according to the first modification example.

### DESCRIPTION OF EMBODIMENTS

Hereinafter, embodiments for carrying out the present disclosure will be described with reference to the drawings. Meanwhile, a dimension and a scale of each section are different from actual ones as appropriate in each drawing. The embodiments described below are preferred specific examples of the present disclosure and are thus added with technically preferred various limitations, but the scope of the present disclosure is not limited to such embodiments unless description for limiting the present disclosure is made in the following description.

### 1. EMBODIMENT

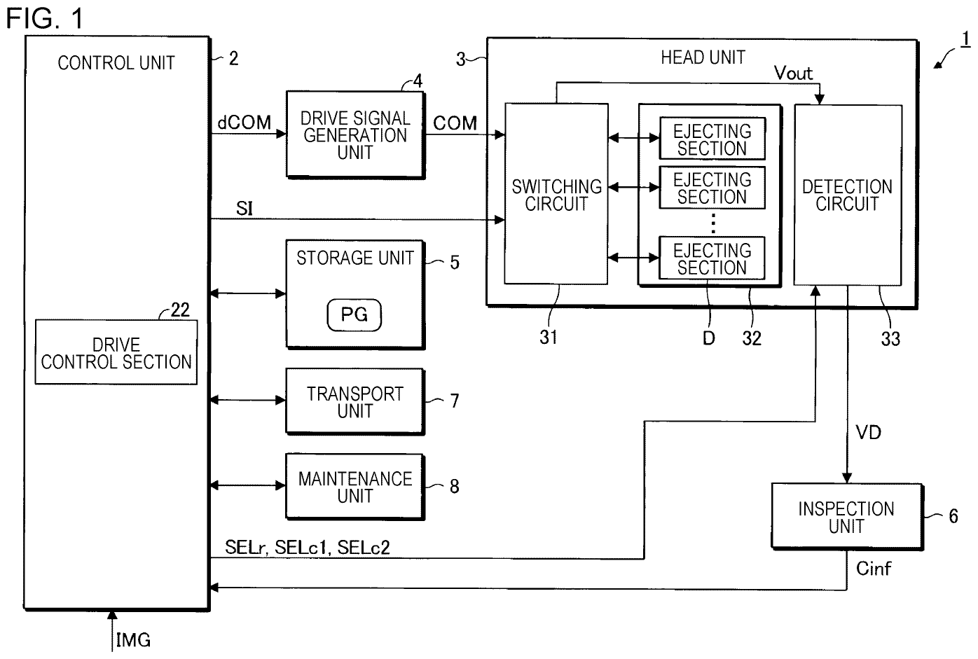

In the present embodiment, a liquid ejecting apparatus will be described by using an ink jet printer that forms an image on recording paper by ejecting an ink as an example. In the present embodiment, the ink is an example of a “liquid”. First, a configuration of an ink jet printer 1 according to the embodiment will be described with reference to FIG. 1.

FIG. 1 is a block diagram illustrating an example of a configuration of the ink jet printer 1 according to the embodiment of the present disclosure.

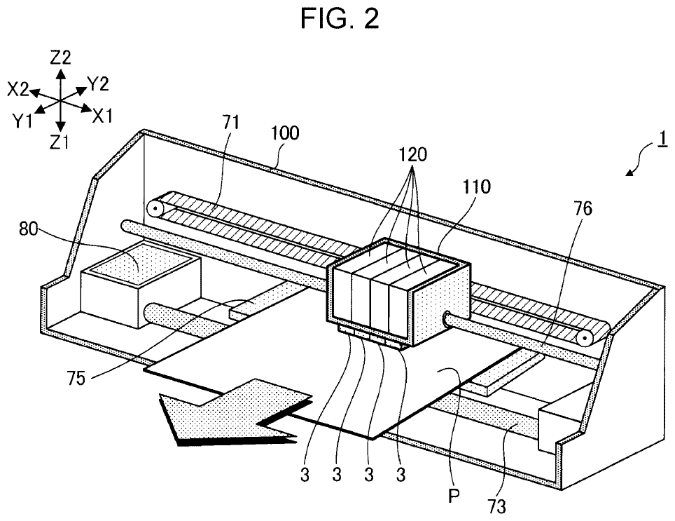

For example, print data IMG indicating an image to be formed by the ink jet printer 1 is supplied to the ink jet printer 1 from a host computer such as a personal computer or a digital camera. The ink jet printer 1 executes a printing process of forming the image indicated by the print data IMG supplied from the host computer on a medium. In the present embodiment, recording paper P illustrated in FIG. 2 to be described below is assumed as the medium.

The ink jet printer 1 includes a control unit 2 that controls each section of the ink jet printer 1, a head unit 3 provided with an ejecting section D for ejecting inks, and a drive signal generation unit 4 that generates a drive signal COM for driving the ejecting section D. Further, the ink jet printer 1 includes a storage unit 5 that stores various types of information such as the print data IMG and a control program PG of the ink jet printer 1, and an inspection unit 6 that determines a state of the ejecting section D. Further, the ink jet printer 1 includes a transport unit 7 for changing a relative position of the recording paper P with respect to the head unit 3, and a maintenance unit 8 for executing a maintenance process for maintaining the ejecting section D provided in the head unit 3. The head unit 3 is an example of a “liquid ejecting head”, the drive signal generation unit 4 is an example of a “drive signal generation section”, and the inspection unit 6 is an example of a “determination section”.

Here, in the present embodiment, it is assumed that the head unit 3 and the drive signal generation unit 4 correspond to each other, and the head unit 3 and the inspection unit 6 correspond to each other. For example, the ink jet printer 1 may include a plurality of head units 3, a plurality of drive signal generation units 4 corresponding to the plurality of head units 3 on a one-to-one basis, and a plurality of inspection units 6 corresponding to the plurality of head units 3 on a one-to-one basis. Alternatively, the ink jet printer 1 may include one head unit 3, one drive signal generation unit 4 corresponding to the one head unit 3, and one inspection unit 6 corresponding to the one head unit 3. In the present embodiment, it is assumed that the ink jet printer 1 includes four head units 3, four drive signal generation units 4 corresponding to the four head units 3 on a one-to-one basis, and four inspection units 6 corresponding to the four head units 3 on a one-to-one basis. Meanwhile, in the following, for convenience of description, one head unit 3 of the four head units 3, one drive signal generation unit 4 of the four drive signal generation units 4 provided corresponding to the one head unit 3, and one inspection unit 6 of the four inspection units 6 provided corresponding to the one head unit 3 will be described.

The control unit 2 is configured with one or a plurality of central processing units (CPU). The control unit 2 may be configured with a programmable logic device such as a field-programmable gate array (FPGA), instead of the CPU or in addition to the CPU. Further, the control unit 2 functions as a drive control section 22 by executing the control program PG stored in the storage unit 5.

The drive control section 22 generates a signal for controlling an operation of each section of the ink jet printer 1, such as a print signal SI and a waveform designation signal dCOM. Here, the waveform designation signal dCOM is a digital signal that defines a waveform of the drive signal COM. In addition, the drive signal COM is an analog signal used to drive the ejecting section D. The print signal SI is a digital signal for designating a type of operation of the ejecting section D. Specifically, the print signal SI is a signal for designating the type of operation of the ejecting section D by designating whether or not the drive signal COM is supplied to the ejecting section D.

When executing a printing process, for example, the drive control section 22 executes the printing process of printing an image indicated by the print data IMG on the recording paper P by controlling the head unit 3 and the transport unit 7. Specifically, when executing the printing process, the drive control section 22 generates a signal for controlling the head unit 3, such as the print signal SI, based on the print data IMG. In addition, the drive control section 22 generates a signal for controlling the drive signal generation unit 4, such as the waveform designation signal dCOM, when executing the printing process. Further, when executing the printing process, the drive control section 22 generates a signal for controlling the transport unit 7. Therefore, in the printing process, the drive control section 22 adjusts the presence or absence of ejection of inks from the ejecting section D[m], the ejecting amount of inks, an ejecting time of the inks, and the like while controlling the transport unit 7 to change a relative position of the recording paper P with respect to the head unit 3. In this manner, the drive control section 22 controls each section of the ink jet printer 1 such that an image corresponding to the print data IMG is formed at the recording paper P.

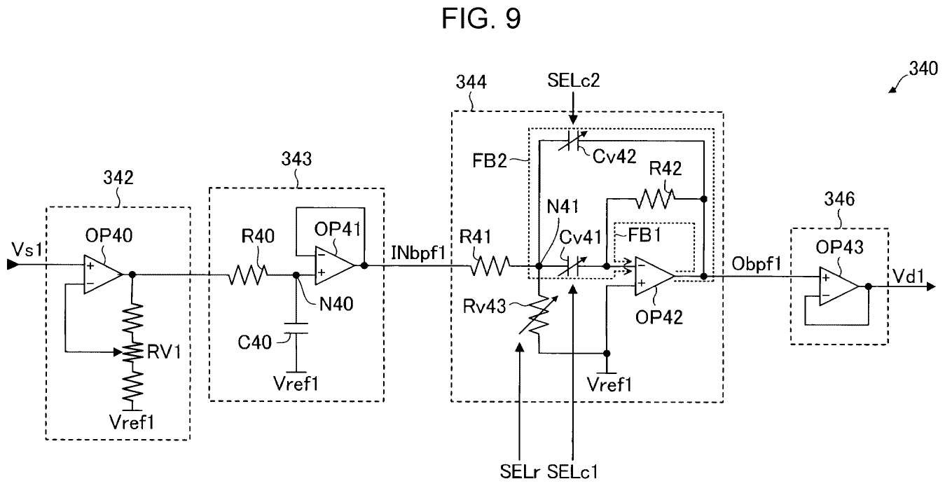

Further, the control unit 2 outputs selection signals SELr, SELc1, and SELc2 to a detection circuit 33 included in the head unit 3. The selection signal SELr is a control signal for adjusting a resistance value of a variable resistor element Rv43 illustrated in FIG. 9 and the like to be described below. The selection signals SELc1 and SELc2 are control signals for respectively adjusting capacitance values of variable capacitors Cv41 and Cv42 illustrated in FIG. 9 and the like to be described below. For example, when executing a process of determining a state of the ejecting section D[m], the selection signals SELr, SELc1, and SELc2 set by a manufacturer of the head unit 3 may be output from the control unit 2 to the detection circuit 33. Alternatively, the selection signals SELr, SELc1, and SELc2 set by the drive control section 22 or the like based on operation information indicating a content of an operation performed on the ink jet printer 1 may be output from the control unit 2 to the detection circuit 33.

The drive signal generation unit 4 includes, for example, a digital analog converter (DAC), and generates the drive signal COM based on the waveform designation signal dCOM supplied from the drive control section 22. For example, the drive signal generation unit 4 generates the drive signal COM including a waveform defined by the waveform designation signal dCOM. The drive signal generation unit 4 outputs the drive signal COM generated based on the waveform designation signal dCOM to a switching circuit 31 included in the head unit 3.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 2.

The head unit 3 has the switching circuit 31, a recording head 32, and the detection circuit 33.

The recording head 32 includes M ejecting sections D. A value of M is a natural number of 1 or more. In the following, among the M ejecting sections D provided in the recording head 32, an m-th ejecting section D may be referred to as an ejecting section D[m]. In this case, the variable m is a natural number that satisfies “1≤m≤M”. In the following description, when a component, a signal, or the like of the ink jet printer 1 corresponds to the ejecting section D[m] among the M ejecting sections D, a reference numeral for representing the component, the signal, or the like may be added with the subscript [m].

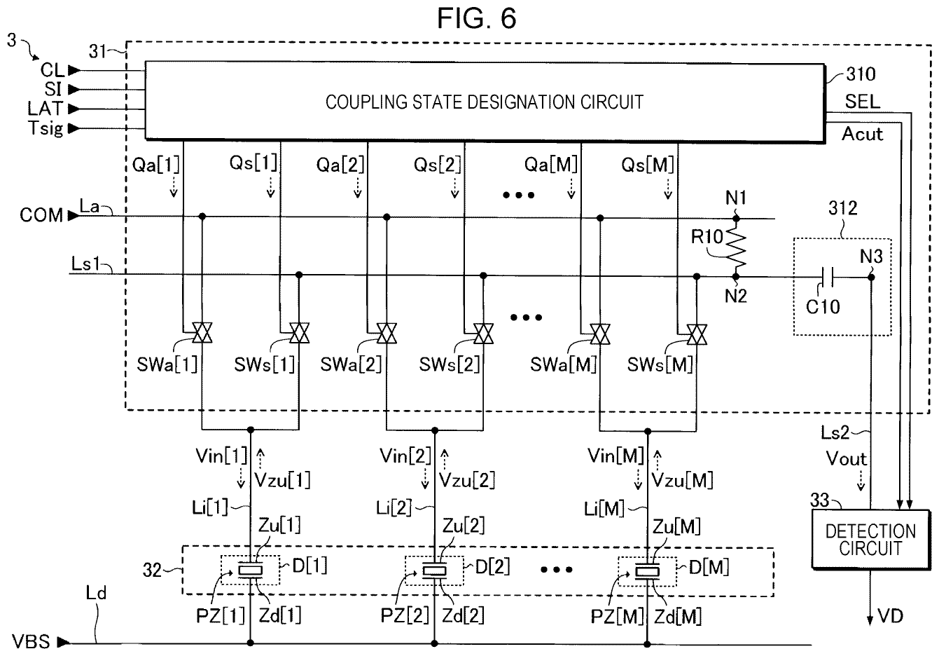

The switching circuit 31 switches whether or not to supply the drive signal COM to the ejecting section D[m], based on the print signal SI. In the following, the drive signal COM supplied to the ejecting section D[m] may be referred to as an individual drive signal Vin[m], as illustrated in FIG. 6 and the like to be described below. The drive signal COM and the individual drive signal Vin are examples of a “drive signal”.

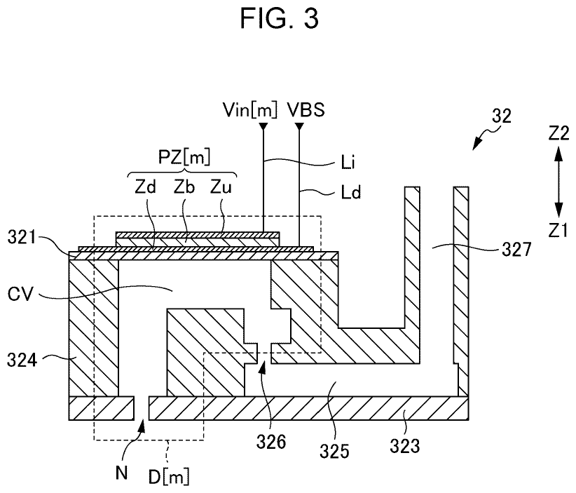

Further, the switching circuit 31 switches whether or not to electrically couple the ejecting section D[m] and the detection circuit 33 based on the print signal SI. When the ejecting section D[m] and the detection circuit 33 are electrically coupled to each other, for example, a detection signal Vout[m] detected from the ejecting section D[m] is supplied to the detection circuit 33 via the switching circuit 31. The detection signal Vout[m] is, for example, an analog signal indicating a change in potential of an upper electrode Zu[m] provided in a piezoelectric element PZ[m] included in the ejecting section D[m]. For example, the detection signal Vout[m] is a residual vibration signal generated by residual vibration in the ejecting section D[m] after the piezoelectric element PZ[m] is driven by the individual drive signal Vin[m]. In this case, a waveform of the detection signal Vout[m] indicates, for example, a waveform of the residual vibration, which is residual vibration in the ejecting section D[m] after the piezoelectric element PZ[m] is driven. The residual vibration of the ejecting section D[m] after the piezoelectric element PZ[m] is driven corresponds to residual vibration of a diaphragm 321 after the piezoelectric element PZ[m] is driven. The piezoelectric element PZ, the upper electrode Zu[m], and the diaphragm 321 will be described below with reference to FIG. 3.

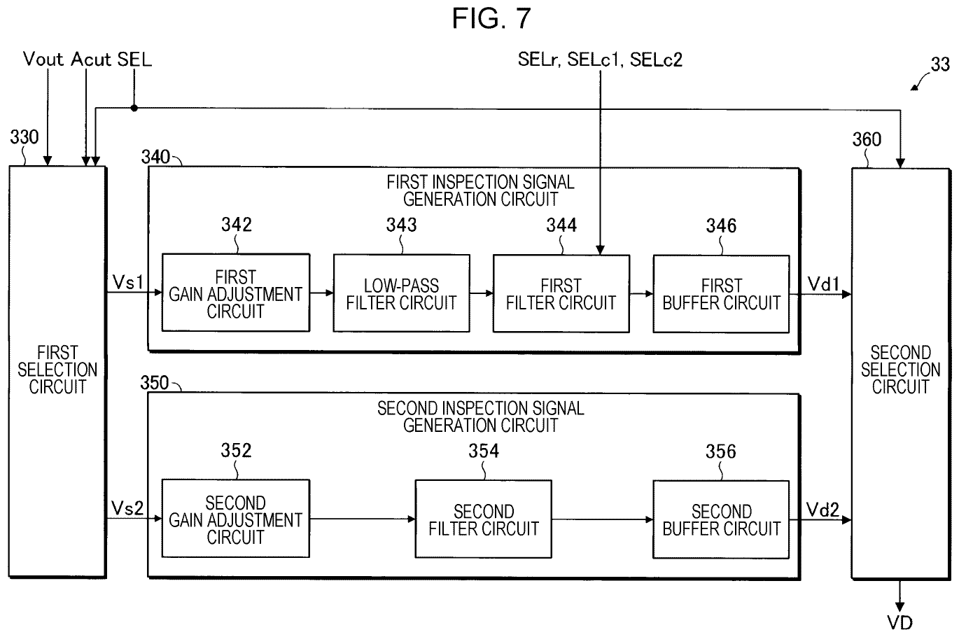

The detection circuit 33 generates an inspection signal VD[m] corresponding to the detection signal Vout[m] as a signal for determining a state of the ejecting section D[m]. Details will be described below with reference to FIG. 7 and the like. For example, the detection circuit 33 generates the inspection signal VD[m] by emulating an attenuation wave of the detection signal Vout[m] indicating the residual vibration of the ejecting section D[m]. Alternatively, the detection circuit 33 generates an inspection signal VD[m] from which frequency components other than a predetermined frequency component are removed from the residual vibration signal. The detection circuit 33 outputs the inspection signal VD[m] corresponding to the detection signal Vout[m] to the inspection unit 6.

The inspection unit 6 determines, for example, the state of the ejecting section D[m] based on the inspection signal VD[m]. For example, the inspection unit 6 determines a thickened state of the ink in the ejecting section D[m]. In this case, the printing process can be prevented from being executed in a state in which an abnormality caused by the thickening of the ink in the ejecting section D[m] occurs. Hereinafter, the process of determining the state of the ejecting section D[m] is also referred to as an ejection state determination process. In addition, in the following, the ejecting section D for which the state is to be determined is also referred to as a determination target ejecting section D.

When executing the ejection state determination process, the drive control section 22 generates a signal for controlling the head unit 3, such as the print signal SI. Further, when executing the ejection state determination process, the drive control section 22 generates a signal for controlling the drive signal generation unit 4, such as the waveform designation signal dCOM. Therefore, the drive control section 22 drives the ejecting section D[m] as the determination target ejecting section D.

Further, when executing the ejection state determination process, the drive control section 22 controls the head unit 3 such that the detection signal Vout[m]corresponding to the ejecting section D[m] driven as the determination target ejecting section D is supplied to the detection circuit 33 by generating the print signal SI. Therefore, the detection circuit 33 generates the inspection signal VD[m] according to the detection signal Vout[m] detected from the ejecting section D[m] driven as the determination target ejecting section D. The inspection unit 6 determines a state of the ejecting section D[m] driven as the determination target ejecting section D based on the inspection signal VD[m] supplied from the detection circuit 33. Further, the inspection unit 6 outputs state information Cinf including information indicating a determination result of the state of the ejecting section D[m] to the control unit 2.

The inspection unit 6 may be included in the control unit 2. For example, the control unit 2 may function as the inspection unit 6 by operating according to the control program PG stored in the storage unit 5.

As described above, in the present embodiment, the ink jet printer 1 executes the maintenance process. For example, the maintenance process includes flushing processing of ejecting inks from the ejecting section D, wiping processing of wiping off a foreign matter such as an ink adhering to the vicinity of a nozzle N of the ejecting section D with a wiper, and pumping processing of suctioning the ink in the ejecting section D with a tube pump or the like. The nozzle N will be described below in FIG. 3.

For example, the ink having a viscosity being increased is ejected from the ejecting section D by the flushing processing. Therefore, the viscosity of the ink in the nozzle N at a start of the printing process can be set to a predetermined viscosity or less. In this case, the thickened ink is ejected from the ejecting section D, and thus a quality of an image to be printed by the printing process can be prevented from being decreased.

The maintenance unit 8 includes a discharge ink receiving section 80 for receiving the ejected ink when the ink in the ejecting section D is ejected, a wiper for wiping off a foreign matter such as an ink adhering to the vicinity of the nozzle N of the ejecting section D, and a tube pump for suctioning the ink, air bubbles, and the like in the ejecting section D, in the flushing processing. The discharge ink receiving section 80 will be described below with reference to FIG. 2. In addition, the wiper and the tube pump will not be illustrated. Next, a schematic internal structure of the ink jet printer 1 will be described with reference to FIG. 2.

FIG. 2 is a perspective diagram illustrating an example of the schematic internal structure of the ink jet printer 1.

As illustrated in FIG. 2, in the present embodiment, it is assumed that the ink jet printer 1 is a serial printer. Specifically, when executing the printing process, the ink jet printer 1 forms dots corresponding to the print data IMG on the recording paper P by ejecting inks from the ejecting section D[m] while transporting the recording paper P in a sub-scanning direction and causing the head unit 3 to reciprocate in a main scanning direction intersecting the sub-scanning direction.

In the below, for convenience of explanation, a three-axis Cartesian coordinate system having an X-axis, a Y-axis, and a Z-axis that are orthogonal to each other will be introduced as appropriate. For example, in the present embodiment, a Y1 direction along the Y-axis is set as the sub-scanning direction, and an X1 direction and an X2 direction along the X-axis are set as the main scanning direction. The X2 direction is a direction opposite to the X1 direction. In the present embodiment, as illustrated in FIG. 2, a Z1 direction along the Z-axis is an ejection direction of the ink from the ejecting section D[m]. In addition, in the following, the X1 direction and the X2 direction are collectively referred to as an X-axis direction, the Y1 direction and a Y2 direction opposite to the Y1 direction are collectively referred to as a Y-axis direction, and the Z1 direction and a Z2 direction opposite to the Z1 direction are collectively referred to as a Z-axis direction. In the present embodiment, as described above, a case where the X-axis, the Y-axis, and the Z-axis are orthogonal to each other is assumed, but the present disclosure is not limited to such an aspect. For example, the X-axis, the Y-axis, and the Z-axis may intersect each other.

The ink jet printer 1 according to the present embodiment includes a housing 100 and a carriage 110 which can reciprocate in the housing 100 in the X-axis direction and on which four head units 3 are mounted.

In the present embodiment, it is assumed that the carriage 110 stores four ink cartridges 120 corresponding to inks having four colors of cyan, magenta, yellow, and black on a one-to-one basis. Further, in the present embodiment, as described above, it is assumed that the ink jet printer 1 includes four head units 3 corresponding to the four ink cartridges 120 on a one-to-one basis. Each ejecting section D[m] receives the ink supplied from the ink cartridge 120 corresponding to the head unit 3 provided with the ejecting section D[m]. Therefore, an inside of each ejecting section D[m] can be filled with the supplied ink, and the filled ink can be ejected from the nozzle N. The ink cartridge 120 may be provided outside the carriage 110.

Further, the ink jet printer 1 according to the present embodiment includes the transport unit 7 as described with reference to FIG. 1. The transport unit 7 includes a carriage transport mechanism 71 for causing the carriage 110 to reciprocate in the X-axis direction, and a carriage guide shaft 76 for reciprocatively supporting the carriage 110 in the X-axis direction. Further, the transport unit 7 includes a medium transport mechanism 73 for transporting the recording paper P and a platen 75 provided in the Z1 direction with respect to the carriage 110. For example, in a printing process, the carriage transport mechanism 71 causes the head unit 3 to reciprocate, together with the carriage 110 along the carriage guide shaft 76 in the X-axis direction, and the medium transport mechanism 73 transports the recording paper P on the platen 75 in the Y1 direction. Therefore, in the printing process, the transport unit 7 causes the carriage transport mechanism 71 and the medium transport mechanism 73 to execute the operation described above, and thus changes a relative position of the recording paper P with respect to the head unit 3, and the ink can land on the entire recording paper P.

Next, a schematic structure of the recording head 32 will be described with reference to FIG. 3.

FIG. 3 is a cross-sectional diagram describing an example of a structure of the ejecting section D. In FIG. 3, a part of the cross section of the recording head 32 when the recording head 32 is cut to include the ejecting section D[m] is schematically illustrated.

The ejecting section D[m] includes a cavity CV filled with inks, the nozzle N communicating with the cavity CV, the piezoelectric element PZ[m] that causes pressure fluctuation in the ink in the cavity CV by supplying the individual drive signal Vin[m], and the diaphragm 321. The ejecting section D[m] ejects the ink in the cavity CV from the nozzle N by driving the piezoelectric element PZ[m] with the individual drive signal Vin[m].

The cavity CV corresponds to a pressure chamber communicating with the nozzle N. For example, the cavity CV is a space partitioned by a cavity plate 324, a nozzle plate 323 in which the nozzle N is formed, and the diaphragm 321. The cavity CV communicates with a reservoir 325 via an ink supply inlet 326. The reservoir 325 communicates with the ink cartridge 120 corresponding to the ejecting section D[m] via an ink intake port 327. The piezoelectric element PZ[m] has the upper electrode Zu[m], a lower electrode Zd[m], and a piezoelectric body Zb[m] provided between the upper electrode Zu[m] and the lower electrode Zd[m]. The piezoelectric body Zb[m] is formed of, for example, a ferroelectric piezoelectric material.

The upper electrode Zu[m] is electrically coupled to a wiring Li to which the individual drive signal Vin[m] is supplied. The lower electrode Zd[m] is electrically coupled to a wiring Ld to which a base potential signal VBS is supplied. Then, the individual drive signal Vin[m] is supplied to the upper electrode Zu[m], so that a voltage is applied between the upper electrode Zu[m] and the lower electrode Zd[m]. The piezoelectric element PZ[m] is displaced in the Z1 direction or the Z2 direction according to the voltage applied between the upper electrode Zu[m] and the lower electrode Zd[m].

In this manner, the piezoelectric element PZ[m]vibrates according to the voltage applied between the upper electrode Zu[m] and the lower electrode Zd[m]. The lower electrode Zd[m] is bonded to the diaphragm 321. Therefore, the piezoelectric element PZ[m] is driven by the individual drive signal Vin[m] and vibrates, so that the diaphragm 321 also vibrates. Then, a volume of the cavity CV and a pressure in the cavity CV are changed due to the vibration of the diaphragm 321, and the ink filled in the cavity CV is ejected from the nozzle N.

In the present embodiment, as an example, it is assumed that the piezoelectric element PZ is displaced in the Z1 direction by changing a potential of the individual drive signal Vin[m] supplied to the ejecting section D[m] from a low potential to a high potential. That is, in the present embodiment, it is assumed that the volume of the cavity CV provided in the ejecting section D[m] is decreased when the potential of the individual drive signal Vin[m] supplied to the ejecting section D[m] is high, in comparison with a case where the potential is low.

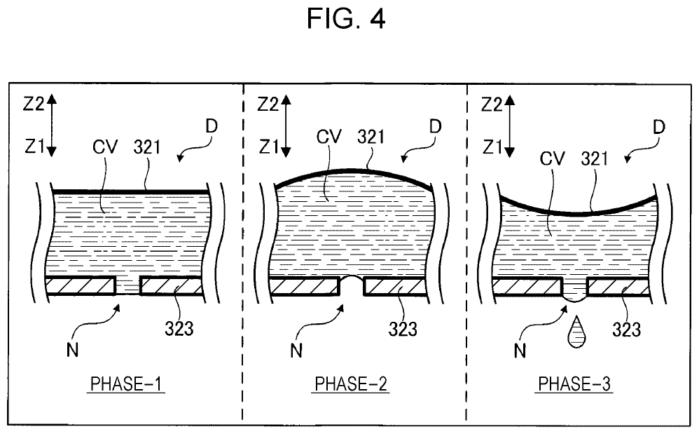

Next, an ejecting operation of an ink by the ejecting section D will be described with reference to FIG. 4.

FIG. 4 is an explanatory diagram describing the ejecting operation of the ink in the ejecting section D.

The drive control section 22 generates a distortion such that the piezoelectric element PZ is displaced in the Z2 direction by changing a potential of the drive signal COM supplied to the piezoelectric element PZ included in the ejecting section D in, for example, a Phase-1 state. Therefore, the diaphragm 321 of the ejecting section D is bent in the Z2 direction. As a result, in a Phase-2 state illustrated in FIG. 4, a volume of the cavity CV of the ejecting section D is expanded as compared with the Phase-1 state. Next, the drive control section 22 generates a distortion such that the piezoelectric element PZ is displaced in the Z1 direction by changing the potential of the drive signal COM, for example, in the Phase-2 state. Therefore, the diaphragm 321 of the ejecting section D is bent in the Z1 direction. As a result, as in a Phase-3 state illustrated in FIG. 4, the volume of the cavity CV rapidly contracts, and a part of the ink filling the cavity CV is ejected as ink droplets from the nozzle N communicating with the cavity CV.

In this manner, the piezoelectric element PZ and the diaphragm 321 included in the ejecting section D are displaced in the Z-axis direction by driving the piezoelectric element PZ included in the ejecting section D by the drive signal COM. Therefore, in the ejecting section D including the diaphragm 321, the piezoelectric element PZ is driven by the drive signal COM, and then residual vibration occurs.

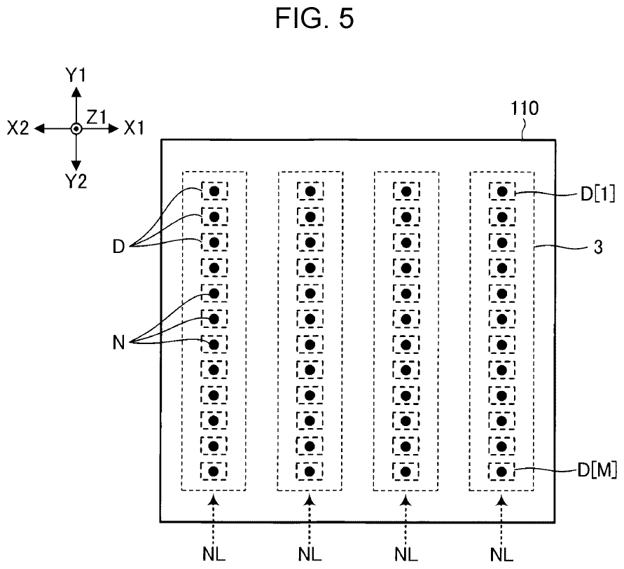

Next, an example of arrangement of the nozzles N will be described with reference to FIG. 5.

FIG. 5 is a plan diagram illustrating an example of arrangement of the nozzles N in the head unit 3. In FIG. 5, an example of the arrangement of the four head units 3 mounted on the carriage 110 and a total of 4M nozzles N provided in the four head units 3 when the ink jet printer 1 is viewed in a plan view from the Z1 direction is illustrated.

A nozzle row NL is provided in each head unit 3 provided at the carriage 110. Here, the nozzle row NL is a plurality of nozzles N provided to extend in a row in a predetermined direction. In the present embodiment, it is assumed as an example that each nozzle row NL is configured with M nozzles N arranged such that the nozzle row NL extends in the Y-axis direction.

Next, an outline of the head unit 3 will be described with reference to FIG. 6.

FIG. 6 is a block diagram illustrating an example of a configuration of the head unit 3.

As described with reference to FIG. 1, the head unit 3 includes the switching circuit 31, the recording head 32, and the detection circuit 33. In addition, the head unit 3 has a wiring La through which the drive signal COM is supplied from the drive signal generation unit 4, a wiring Ls1 through which a potential signal Vzu is supplied to a high-pass filter circuit 312 to be described below, and a wiring Ls2 through which the detection circuit 33 is supplied with the detection signal Vout. Further, the head unit 3 has the wiring Li[m] for supplying the individual drive signal Vin[m] to the ejecting section D[m] and the wiring Ld for supplying the base potential signal VBS. In FIG. 6, wirings to which the selection signal SELr is supplied, wirings to which the selection signal SELc1 is supplied, and wirings to which the selection signal SELc2 is supplied are omitted in order to make the drawing easy to see.

The switching circuit 31 includes M switches SWa[1] to SWa[M] that correspond to the M ejecting sections D[1] to D[M] on a one-to-one basis and M switches SWs[1] to SWs[M] that correspond to the M ejecting sections D[1] to D[M] on a one-to-one basis, and a coupling state designation circuit 310. Further, the switching circuit 31 includes the high-pass filter circuit 312 that outputs the detection signal Vout[m] from the potential signal Vzu[m] indicating a potential of the upper electrode Zu[m] provided in the piezoelectric element PZ[m] to the detection circuit 33, the detection signal Vout[m] being obtained by removing a DC component from the potential signal Vzu[m]. The potential signal Vzu[m] that is a source of the detection signal Vout[m] may be regarded as a “residual vibration signal”.

The high-pass filter circuit 312 includes, for example, a capacitor C10 having one end electrically coupled to the wiring Ls1 and the other end electrically coupled to the wiring Ls2. The switching circuit 31 includes a resistor element R10 having one end electrically coupled to the wiring La and the other end electrically coupled to the wiring Ls1. The resistor element R10 functions as a bias resistor that supplies a voltage of the drive signal COM to the wiring Ls1. In the following, a node to which one end of the resistor element R10 is coupled may be referred to as a node N1, and a node to which the other end of the resistor element R10 is coupled may be referred to as a node N2. For example, the resistor element R10 and the capacitor C10 are coupled to the node N2. In addition, for example, the detection circuit 33 is coupled to the node N2 via the capacitor C10. In the following, a node to which the capacitor C10 and the detection circuit 33 are coupled may be referred to as a node N3.

A coupling state designation circuit 310 designates a coupling state of each of the M switches SWa and the M switches SWs. For example, the coupling state designation circuit 310 generates coupling state designation signals Qa[m] and Qs[m] based on at least a part signal of the print signal SI, a latch signal LAT, and a period defining signal Tsig supplied from the drive control section 22. The coupling state designation signal Qa[m] is a signal for designating ON or OFF of the switch SWa[m], and the coupling state designation signal Qs[m] is a signal for designating ON or OFF of the switch SWs[m]. Further, the coupling state designation circuit 310 generates a selection signal SEL and a detection period signal Acut, based on at least a part of the print signal SI, the latch signal LAT, and the period defining signal Tsig. The selection signal SEL and the detection period signal Acut are supplied to the detection circuit 33.

In the present embodiment, it is assumed that each of the M switches SWa and the M switches SWs is configured with a transfer gate including a P-channel transistor and an N-channel transistor coupled in parallel. Meanwhile, each of the M number of switches SWa and the M number of switches SWs may be configured with one of the P-channel transistor and the N-channel transistor.

The switch SWa[m] switches conduction and non-conduction between the wiring La and the upper electrode Zu[m] of the piezoelectric element PZ[m] provided in the ejecting section D[m], based on the coupling state designation signal Qa[m]. That is, the switch SWa[m] switches conduction and non-conduction between the wiring La and the wiring Li[m] coupled to the upper electrode Zu[m], based on the coupling state designation signal Qa[m]. In the present embodiment, the switch SWa[m] is turned on when the coupling state designation signal Qa[m] is at a high level, and is turned off when the coupling state designation signal Qa[m] is at a low level. When the switch SWa[m] is turned on, the drive signal COM supplied to the wiring La is supplied to the upper electrode Zu[m] of the ejecting section D[m] as the individual drive signal Vin[m] via the wiring Li[m]. That is, the individual drive signal Vin[m] is the drive signal COM supplied to the piezoelectric element PZ[m] included in the ejecting section D[m] via the switch SWa [m].

The switch SWs[m] switches conduction and non-conduction between the wiring Ls1 and the upper electrode Zu[m] of the piezoelectric element PZ[m] provided in the ejecting section D[m], based on the coupling state designation signal Qs[m]. That is, the switch SWs[m] switches conduction and non-conduction between the wiring Ls1 and the wiring Li[m] coupled to the upper electrode Zu[m], based on the coupling state designation signal Qs[m]. In the present embodiment, the switch SWs[m] is turned on when the coupling state designation signal Qs[m] is at a high level, and is turned off when the coupling state designation signal Qs[m] is at a low level.

For example, the coupling state designation signal Qs[m] becomes a high level when residual vibration of the ejecting section D[m] is detected. Therefore, the residual vibration of the determination target ejecting section D is detected. When the switch SWs[m] is turned on, the potential signal Vzu[m] indicating a potential of the upper electrode Zu[m] of the piezoelectric element PZ[m] included in the determination target ejecting section D[m] is supplied to the high-pass filter circuit 312 via the wiring Li[m] and the wiring Ls1. The high-pass filter circuit 312 supplies the detection signal Vout [m], from which a DC component of the potential signal Vzu [m] is removed, to the detection circuit 33 via the wiring Ls2. The detection circuit 33 generates the inspection signal VD[m] corresponding to the detection signal Vout[m].

Meanwhile, in order to drive the piezoelectric element PZ, the drive signal COM having a large amplitude is required, but the detection circuit 33 is an analog signal processing circuit, and thus a large dynamic range is not required. Therefore, in the present embodiment, a high-power supply potential of the detection circuit 33 is lower than the maximum potential of the drive signal COM. For example, the maximum potential of the drive signal COM is approximately 42 V, the high-power supply potential of the detection circuit 33 is approximately 3.3 V, and a low-power supply potential of the detection circuit 33 is approximately 0 V. In this manner, since the high-power supply potential of the detection circuit 33 is lower than the maximum potential of the drive signal COM, coupling between the piezoelectric element PZ and the detection circuit 33 is not suitable for DC coupling. In the present embodiment, the detection circuit 33 can be normally operated by removing a DC component of the potential signal Vzu by the high-pass filter circuit 312.

Next, an outline of the detection circuit 33 will be described with reference to FIG. 7.

FIG. 7 is a block diagram illustrating an example of a configuration of the detection circuit 33.

The detection circuit 33 includes a first selection circuit 330, a first inspection signal generation circuit 340, a second inspection signal generation circuit 350, and a second selection circuit 360.

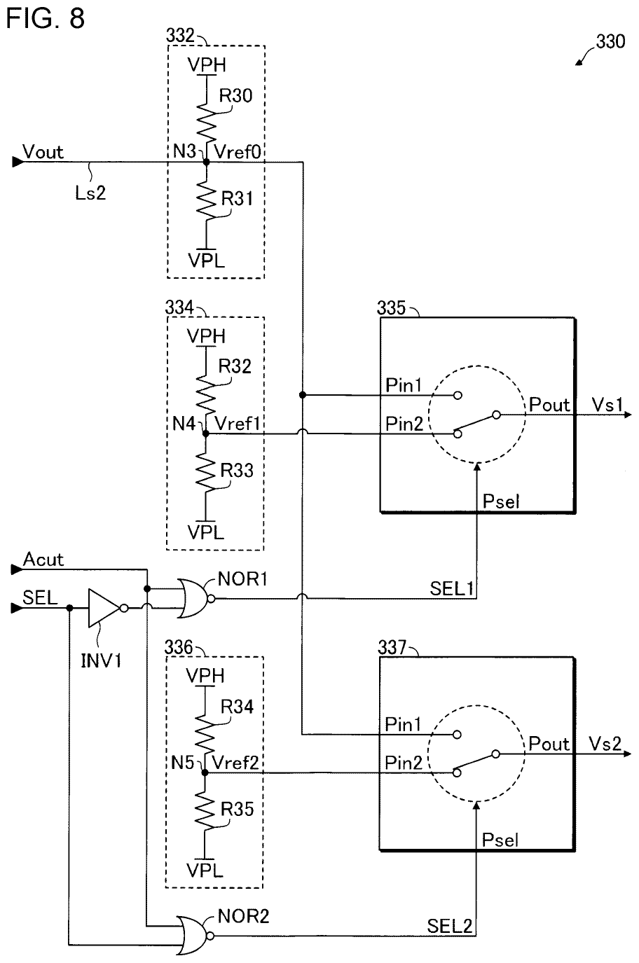

The first selection circuit 330 selects one of the detection signal Vout and the first reference potentials Vref1 illustrated in FIG. 8 as a first input signal Vs1, based on the selection signal SEL and the detection period signal Acut. That is, the first selection circuit 330 supplies one of the detection signal Vout and the first reference potential Vref1 as the first input signal Vs1 to the first inspection signal generation circuit 340, based on the selection signal SEL and the detection period signal Acut.

In addition, the first selection circuit 330 selects one of the detection signal Vout and a second reference potential Vref2 illustrated in FIG. 8 as a second input signal Vs2, based on the selection signal SEL and the detection period signal Acut. That is, the first selection circuit 330 supplies one of the detection signal Vout and the second reference potential Vref2 to the second inspection signal generation circuit 350 as the second input signal Vs2, based on the selection signal SEL and the detection period signal Acut.

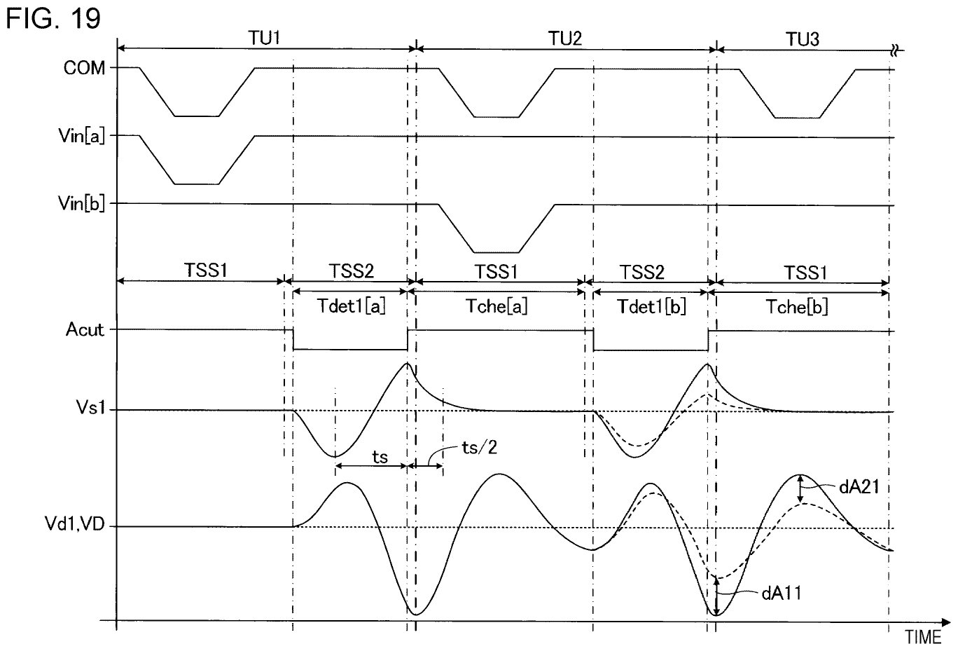

The first inspection signal generation circuit 340 generates, for example, a first inspection signal Vd1 that emulates an attenuation wave of the detection signal Vout. Therefore, the first inspection signal Vd1 is generated as a pseudo residual vibration signal that emulates residual vibration of the ejecting section D. In the present embodiment, a case where the first inspection signal Vd1 is generated based on the residual vibration having ¼ cycle or more and less than one cycle of the ejecting section D is assumed. For example, the first inspection signal generation circuit 340 generates a pseudo residual vibration signal based on the detection signal Vout having ¼ cycle or more and less than one cycle, and outputs the generated pseudo residual vibration signal as the first inspection signal Vd1. The cycle of the first inspection signal Vd1 output from the first inspection signal generation circuit 340 is equal to or longer than one cycle, as illustrated in FIG. 19 described below.

The first inspection signal generation circuit 340 includes, for example, a first gain adjustment circuit 342, a low-pass filter circuit 343, a first filter circuit 344, and a first buffer circuit 346. The first gain adjustment circuit 342 adjusts an amplitude of the first input signal Vs1. The low-pass filter circuit 343 attenuates a high-band frequency component of the first input signal Vs1. The high-band frequency component is, for example, a frequency component higher than a frequency band of the residual vibration. The first filter circuit 344 is a multiplex feedback type band pass filter. The first buffer circuit 346 converts an impedance, and outputs the first inspection signal Vd1 having a low impedance. The first inspection signal generation circuit 340 is an example of a “signal generation section”, the first filter circuit 344 is an example of a “filter circuit”, and the low-pass filter circuit 343 is an example of a “low-pass filter”. Details of the first inspection signal generation circuit 340 will be described below with reference to FIG. 9.

The second inspection signal generation circuit 350 generates, for example, a second inspection signal Vd2 from which a frequency component other than a predetermined frequency component is removed from the detection signal Vout. Therefore, the second inspection signal Vd2 is generated as a detection residual vibration signal corresponding to a signal of the predetermined frequency component of the detection signal Vout indicating the residual vibration of the ejecting section D. The predetermined frequency component is, for example, a frequency component corresponding to a frequency band of the residual vibration. In the present embodiment, a case where the second inspection signal Vd2 is generated based on residual vibration during one cycle or more of the ejecting section D is assumed. For example, the second inspection signal generation circuit 350 generates a detection residual vibration signal based on the detection signal Vout having one cycle or more, and outputs the generated detection residual vibration signal as the second inspection signal Vd2.

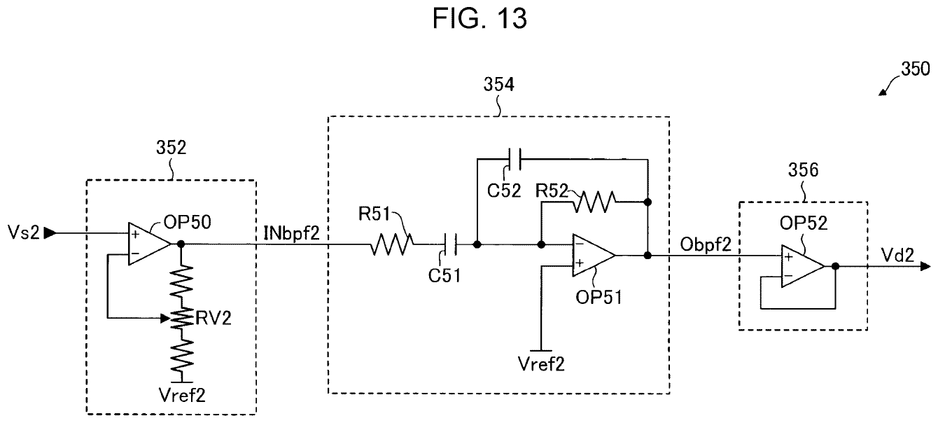

The second inspection signal generation circuit 350 includes a second gain adjustment circuit 352 configured in the same manner as the first gain adjustment circuit 342, a second filter circuit 354, and a second buffer circuit 356 configured in the same manner as the first buffer circuit 346. The second filter circuit 354 is a band pass filter that passes a signal of the predetermined frequency component. Details of the second inspection signal generation circuit 350 will be described below in FIG. 13.

The second selection circuit 360 selects one of the first inspection signal Vd1 and the second inspection signal Vd2 as the inspection signal VD based on the selection signal SEL. That is, the second selection circuit 360 supplies one of the first inspection signal Vd1 and the second inspection signal Vd2 to the inspection unit 6 as the inspection signal VD based on the selection signal SEL. The second selection circuit 360 may, for example, exclusively switch whether to supply the first inspection signal Vd1 to the inspection unit 6 or to supply the second inspection signal Vd2 to the inspection unit 6 based on the selection signal SEL. In the present embodiment, the second selection circuit 360 supplies the first inspection signal Vd1 as the inspection signal VD to the inspection unit 6 when the selection signal SEL is at a high level, and supplies the second inspection signal Vd2 as the inspection signal VD to the inspection unit 6 when the selection signal SEL is at a low level.

In this manner, in the present embodiment, whether the inspection unit 6 determines a state of the ejecting section D based on the first inspection signal Vd1 and whether the inspection unit 6 determines the state of the ejecting section D based on the second inspection signal Vd2 can be switched based on the selection signal SEL. Each of the case where the inspection unit 6 determines the state of the ejecting section D based on the first inspection signal Vd1 and the case where the inspection unit 6 determines the state of the ejecting section D based on the second inspection signal Vd2 may be a mode when the state of the ejecting section D is determined. In the following, a case where the inspection unit 6 determines the state of the ejecting section D based on the first inspection signal Vd1 may be referred to as a first mode, and a case where the inspection unit 6 determines the state of the ejecting section D based on the second inspection signal Vd2 may be referred to as a second mode. In this case, the operation of the inspection unit 6 is also described as follows. For example, the inspection unit 6 determines the state of the ejecting section D in a mode selected based on the selection signal SEL from among a plurality of modes including the first mode and the second mode.

In the present embodiment, as described above, the first inspection signal Vd1 is generated based on the residual vibration of less than one cycle of the ejecting section D, and the second inspection signal Vd2 is generated based on the residual vibration of one cycle or more of the ejecting section D. Therefore, when the state of the ejecting section D is determined based on the first inspection signal Vd1, a time assigned to the detection of the residual vibration of the ejecting section D can be reduced as compared with the case where the state of the ejecting section D is determined based on the second inspection signal Vd2. Therefore, in the present embodiment, a time required for determining the state of the plurality of ejecting sections D can be prevented from being increased.

Next, an outline of the first selection circuit 330 will be described with reference to FIG. 8.

FIG. 8 is a circuit diagram illustrating an example of a configuration of the first selection circuit 330.

The first selection circuit 330 includes a reference potential generation circuit 332, a first reference potential generation circuit 334, a second reference potential generation circuit 336, a first switching circuit 335, a second switching circuit 337, an inverter INV1, and negative logic sum circuits NOR1 and NOR2.

The reference potential generation circuit 332 includes resistor elements R30 and R31 coupled in series between a wiring to which a potential VPH is supplied and a wiring to which a potential VPL is supplied. The potential VPH is a high-power supply potential of the detection circuit 33, and the potential VPL is a low-power supply potential of the detection circuit 33. One end of the resistor element R30 is coupled to the wiring to which the potential VPH is supplied, and the other end of the resistor element R30 is coupled to the wiring Ls2 to which the detection signal Vout is supplied. In addition, one end of the resistor element R31 is coupled to the wiring Ls2, and the other end of the resistor element R31 is coupled to the wiring to which the potential VPL is supplied. That is, the detection signal Vout is supplied to the node N3 to which the resistor element R30 and the resistor element R31 are electrically coupled. Resistance values of the resistor elements R30 and R31 are set such that, for example, a reference potential Vref0, which is a potential of the node N3 when a potential of the node N2 illustrated in FIG. 6 is maintained at a constant potential, becomes a center potential between the potential VPH and the potential VPL. For example, by setting the resistance value of each of the resistor elements R30 and R31 to 150 kΩ, the reference potential Vref0 is set to the center potential between the potential VPH and the potential VPL. The node N3 is also a node to which the capacitor C10 is coupled, as described with reference to FIG. 6.

The first reference potential generation circuit 334 includes resistor elements R32 and R33 coupled in series between a wiring to which the potential VPH is supplied and a wiring to which the potential VPL is supplied. One end of the resistor element R32 is coupled to the wiring to which the potential VPH is supplied, the other end of the resistor element R33 is coupled to one end of the resistor element R33, and the other end of the resistor element R33 is coupled to the wiring to which the potential VPL is supplied. In the following, a node to which the resistor element R32 and the resistor element R33 are coupled may be referred to as a node N4. Resistance values of the resistor elements R32 and R33 are set, for example, such that the first reference potential Vref1, which is a potential of the node N4, becomes a center potential between the potential VPH and the potential VPL. An output impedance of the first reference potential generation circuit 334 is preferably smaller than an output impedance of the reference potential generation circuit 332 to reduce influence of a noise on the first inspection signal generation circuit 340 when the noise is generated in the node N4. For example, by setting the resistance value of each of the resistor elements R32 and R33 to 1.5 kΩ, the first reference potential Vref1 is set to the center potential between the potential VPH and the potential VPL.

The second reference potential generation circuit 336 includes resistor elements R34 and R35 coupled in series between a wiring to which the potential VPH is supplied and a wiring to which the potential VPL is supplied. One end of the resistor element R34 is coupled to the wiring to which the potential VPH is supplied, the other end of the resistor element R34 is coupled to one end of the resistor element R35, and the other end of the resistor element R35 is coupled to the wiring to which the potential VPL is supplied. In the following, a node to which the resistor element R34 and the resistor element R35 are coupled may be referred to as a node N5. Resistance values of the resistor elements R34 and R35 are set, for example, such that the second reference potential Vref2, which is a potential of the node N5, becomes a center potential between the potential VPH and the potential VPL. An output impedance of the second reference potential generation circuit 336 is preferably smaller than an output impedance of the reference potential generation circuit 332 to reduce influence of a noise on the second inspection signal generation circuit 350 when the noise is generated in the node N5. For example, by setting the resistance value of each of the resistor elements R34 and R35 to 1.5 kΩ, the second reference potential Vref2 is set to the center potential between the potential VPH and the potential VPL.

Each of the first switching circuit 335 and the second switching circuit 337 has, for example, a first input terminal Pin1, a second input terminal Pin2, an output terminal Pout, and a control terminal Psel. Each of the first switching circuit 335 and the second switching circuit 337 switches between making the first input terminal Pin1 and the output terminal Pout conductive and making the second input terminal Pin2 and the output terminal Pout conductive, according to a signal supplied to the control terminal Psel. For example, each of the first switching circuit 335 and the second switching circuit 337 makes the first input terminal Pin1 and the output terminal Pout conductive and makes the second input terminal Pin2 and the output terminal Pout non-conductive when a level of the control terminal Psel is a high level. In addition, each of the first switching circuit 335 and the second switching circuit 337 makes the second input terminal Pin2 and the output terminal Pout conductive and makes the first input terminal Pin1 and the output terminal Pout non-conductive when the level of the control terminal Psel is a low level.

For example, the first input terminal Pin1 of the first switching circuit 335 is coupled to the node N3, the second input terminal Pin2 of the first switching circuit 335 is coupled to the node N4, and the output terminal Pout of the first switching circuit 335 is coupled to the first inspection signal generation circuit 340. That is, the detection signal Vout is input to the first input terminal Pin1 of the first switching circuit 335, and the first reference potential Vref1 is supplied to the second input terminal Pin2 of the first switching circuit 335. An input selection signal SEL1 is supplied to the control terminal Psel of the first switching circuit 335. For example, the first inspection signal generation circuit 340 switches from a state of being coupled to the output terminal Pout via the second input terminal Pin2 to a state of being coupled to the output terminal Pout via the first input terminal Pin1, and then starts an output of the first inspection signal Vd1 indicating a pseudo residual vibration signal.

For example, the first input terminal Pin1 of the second switching circuit 337 is coupled to the node N3, the second input terminal Pin2 of the second switching circuit 337 is coupled to the node N5, and the output terminal Pout of the second switching circuit 337 is coupled to the second inspection signal generation circuit 350. That is, the detection signal Vout is input to the first input terminal Pin1 of the second switching circuit 337, and the second reference potential Vref2 is supplied to the second input terminal Pin2 of the second switching circuit 337. The input selection signal SEL2 is supplied to the control terminal Psel of the second switching circuit 337.

The inverter INV1 outputs an inversion signal of the selection signal SEL supplied from the coupling state designation circuit 310 to the negative logic sum circuit NOR1. The inversion signal of the selection signal SEL is a signal in which a level of the selection signal SEL is inverted. Specifically, the inversion signal of the selection signal SEL is a low level signal when the selection signal SEL is at a high level, and is a high level signal when the selection signal SEL is at a low level.

The negative logic sum circuit NOR1 outputs a calculation result of a negative logic sum of the detection period signal Acut supplied from the coupling state designation circuit 310 and the inversion signal of the selection signal SEL as the input selection signal SEL1 to the control terminal Psel of the first switching circuit 335.

The negative logic sum circuit NOR2 outputs a calculation result of a negative logic sum of the selection signal SEL and the detection period signal Acut supplied from the coupling state designation circuit 310 as the input selection signal SEL2 to the control terminal Psel of the second switching circuit 337.

The first selection circuit 330 illustrated in FIG. 8 supplies the detection signal Vout as the first input signal Vs1 to the first inspection signal generation circuit 340 when the selection signal SEL is at a high level and the detection period signal Acut is at a low level. Further, the first selection circuit 330 supplies the first reference potential Vref1 as the first input signal Vs1 to the first inspection signal generation circuit 340 when the selection signal SEL is at a high level and the detection period signal Acut is at a high level. When the selection signal SEL is at a low level, the first selection circuit 330 supplies the first reference potential Vref1 as the first input signal Vs1 to the first inspection signal generation circuit 340, regardless of the level of the detection period signal Acut.

Further, the first selection circuit 330 supplies the detection signal Vout as the second input signal Vs2 to the second inspection signal generation circuit 350 when the selection signal SEL is at a low level and the detection period signal Acut is at a low level. Further, when the selection signal SEL is at a low level and the detection period signal Acut is at a high level, the first selection circuit 330 supplies the second reference potential Vref2 as the second input signal Vs2 to the second inspection signal generation circuit 350. When the selection signal SEL is at a high level, the first selection circuit 330 supplies the second reference potential Vref2 as the second input signal Vs2 to the second inspection signal generation circuit 350, regardless of the level of the detection period signal Acut.

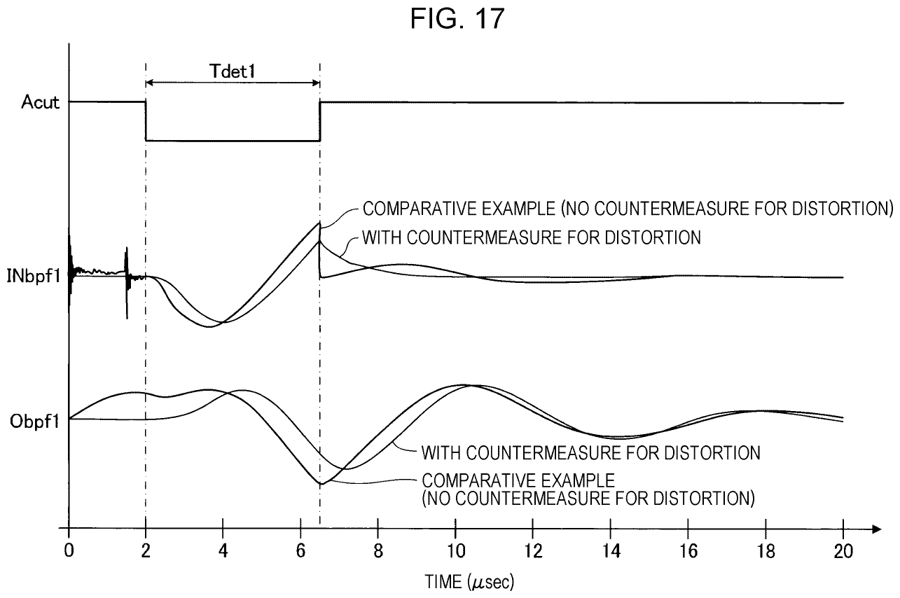

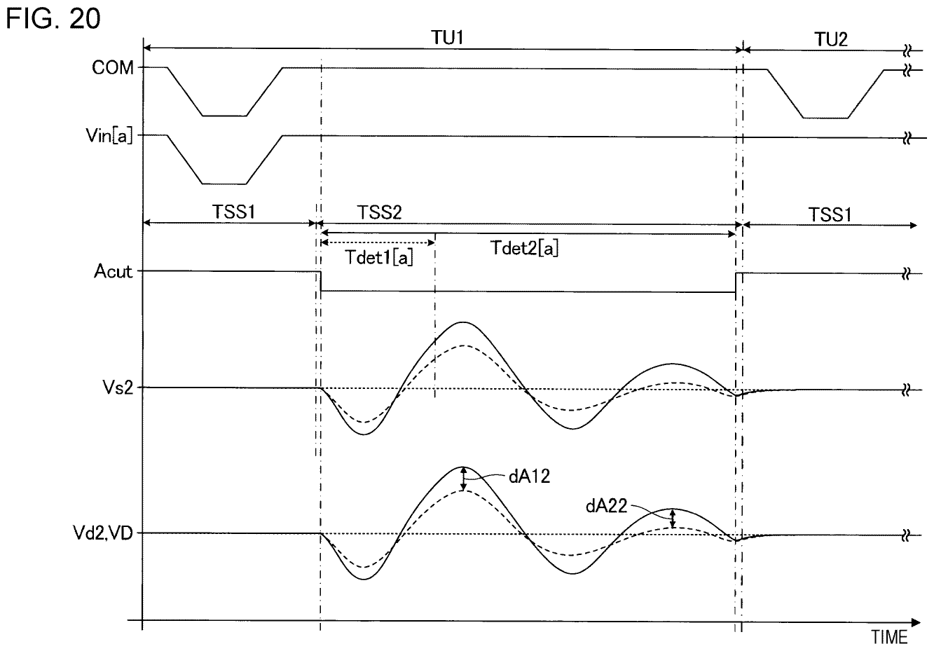

In this manner, in the present embodiment, the first inspection signal generation circuit 340 is selected as a circuit for generating the inspection signal VD when the selection signal SEL is at a high level, and the second inspection signal generation circuit 350 is selected as a circuit for generating the inspection signal VD when the selection signal SEL is at a low level. The detection signal Vout is input to the first inspection signal generation circuit 340 or the second inspection signal generation circuit 350 in a period in which the detection period signal Acut is at a low level. In the following, the period in which the detection period signal Acut is at a low level is also referred to as a detection period Tdet1 or Tdet2 as illustrated in FIGS. 17 and 20.

The configuration of the first selection circuit 330 is not limited to the example illustrated in FIG. 8. For example, the second reference potential generation circuit 336 may be omitted. In this case, the second input terminal Pin2 of the second switching circuit 337 is coupled to, for example, the node N4.

Next, an outline of the first inspection signal generation circuit 340 will be described with reference to FIG. 9.

FIG. 9 is a circuit diagram illustrating an example of a configuration of the first inspection signal generation circuit 340.

As described in FIG. 7, the first inspection signal generation circuit 340 includes the first gain adjustment circuit 342, the low-pass filter circuit 343, the first filter circuit 344, and the first buffer circuit 346.

The first gain adjustment circuit 342 is, for example, a negative feedback type amplifier including an operational amplifier OP40 and a variable resistor RV1. For example, the first input signal Vs1 is supplied from the first switching circuit 335 to a non-inversion input terminal of the operational amplifier OP40, and a signal obtained by dividing an output signal of the operational amplifier OP40 with the variable resistor RV1 is fed back to an inversion input terminal of the operational amplifier OP40. For example, one end of the variable resistor RV1 is coupled to an output terminal of the operational amplifier OP40, the other end of the variable resistor RV1 is coupled to a wiring to which the first reference potential Vref1 is supplied, and a moving contact of the variable resistor RV1 is coupled to the inversion input terminal of the operational amplifier OP40. The first gain adjustment circuit 342 can output a signal obtained by adjusting an amplitude of the first input signal Vs1 to the low-pass filter circuit 343 by adjusting, for example, a position of the moving contact of the variable resistor RV1.

The low-pass filter circuit 343 includes, for example, a resistor element R40, a capacitor C40, and an operational amplifier OP41. One end of the resistor element R40 is coupled to an output terminal of the operational amplifier OP40 of the first gain adjustment circuit 342, and the other end of the resistor element R40 is coupled to a node N40. One end of the capacitor C40 is coupled to the node N40, and the other end of the capacitor C40 is coupled to a wiring to which the first reference potential Vref1 is supplied. In addition, a non-inversion input terminal of an operational amplifier OP42 is coupled to the node N40, and an inversion input terminal of the operational amplifier OP42 is coupled to an output terminal of the operational amplifier OP42. A first filter input signal INbpf1, which is a signal of the output terminal of the operational amplifier OP42, is input to the first filter circuit 344. That is, the first filter input signal INbpf1 obtained by attenuating a high-band frequency component from a signal obtained by adjusting an amplitude of the first input signal Vs1 is input to the first filter circuit 344.

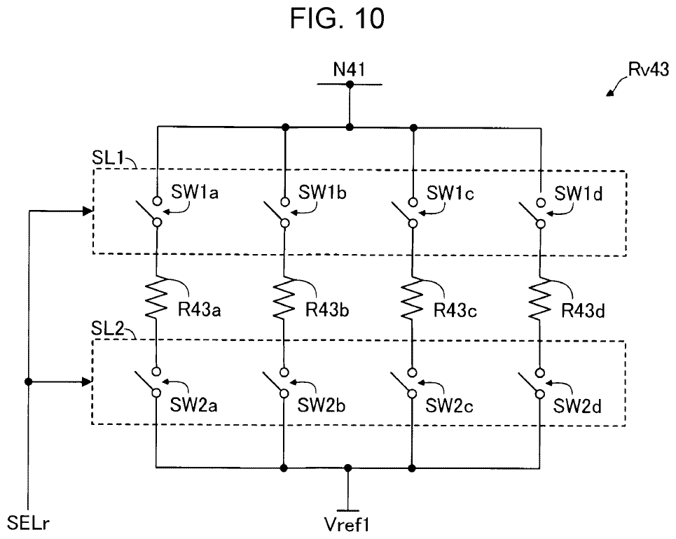

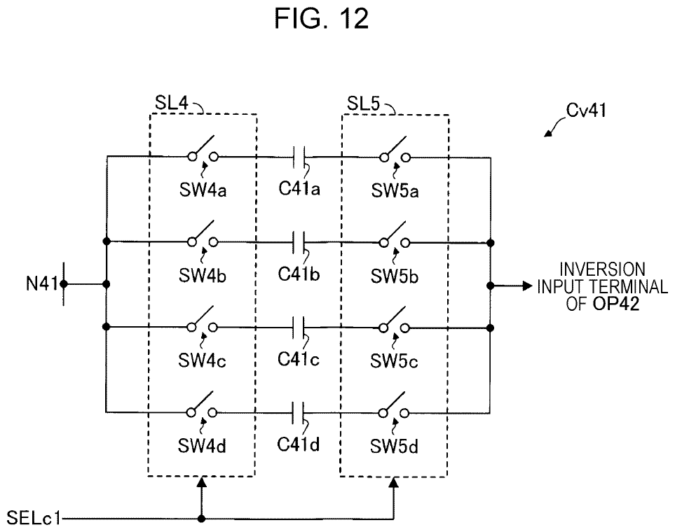

The first filter circuit 344 is, for example, a multiplex feedback type band pass filter including a resistor elements R41 and R42, the variable resistor element Rv43 having an adjustable resistance value, the variable capacitors Cv41 and Cv42 having an adjustable capacitance value, and the operational amplifier OP42. One of the variable capacitors Cv41 and Cv42 may be replaced with a capacitor having a non-adjustable capacitance value. That is, the first filter circuit 344 may have a capacitor having a non-adjustable capacitance value, instead of the variable capacitor Cv41, or may have a capacitor having a non-adjustable capacitance value, instead of the variable capacitor Cv42. The capacitance value indicates a capacitance. An example of a configuration of the variable resistor element Rv43 will be described below in FIG. 10 and the like, and an example of a configuration of the variable capacitor Cv41 will be described below in FIG. 12.

Here, the resistor element R41 is an example of a “first resistor”, and the resistor element R42 is an example of a “second resistor”. The variable resistor element Rv43 is an example of a “variable resistor section”. The variable capacitor Cv41 is an example of a “first capacitor”, and the variable capacitor Cv42 is an example of a “second capacitor”. The operational amplifier OP42 is an example of a “differential amplifier”, the inversion input terminal of the operational amplifier OP42 is an example of a “first input terminal”, and the non-inversion input terminal of the operational amplifier OP42 is an example of a “second input terminal”. In addition, a node N41 to be described below is an example of a “first node”.

One end of the resistor element R41 is coupled to an output terminal of the operational amplifier OP41 of the low-pass filter circuit 343, and the other end of the resistor element R41 is coupled to the node N41. One end of the variable capacitor Cv41 is coupled to the node N41, and the other end of the variable capacitor Cv41 is coupled to the inversion input terminal of the operational amplifier OP42. One end of the resistor element R42 is coupled to the inversion input terminal of the operational amplifier OP42, and the other end of the resistor element R42 is coupled to the output terminal of the operational amplifier OP42. The non-inversion input terminal of the operational amplifier OP42 is coupled to a wiring to which the first reference potential Vref1 is supplied. One end of the variable resistor element Rv43 is coupled to the node N41, and the other end of the variable resistor element Rv43 is coupled to a wiring to which the first reference potential Vref1 is supplied. In addition, one end of the variable capacitor Cv42 is coupled to the node N41, and the other end of the variable capacitor Cv42 is coupled to the output terminal of the operational amplifier OP42.

For example, the first filter input signal INbpf1 is input to the inversion input terminal of the operational amplifier OP42 via the resistor element R41 and the variable capacitor Cv41. That is, the first input signal Vs1 is input to the inversion input terminal of the operational amplifier OP42 via the first gain adjustment circuit 342, the low-pass filter circuit 343, the resistor element R41, and the variable capacitor Cv41. An output signal of the operational amplifier OP42 is fed back to the inversion input terminal of the operational amplifier OP42 by a first feedback path FB1. The output signal of the operational amplifier OP42 is fed back to the inversion input terminal of the operational amplifier OP42 by a second feedback path FB2 different from the first feedback path FB1. The first feedback path FB1 is, for example, a feedback path for feeding back the output signal of the operational amplifier OP42 to the inversion input terminal of the operational amplifier OP42 via the resistor element R42. In addition, the second feedback path FB2 is, for example, a feedback path for feeding back the output signal of the operational amplifier OP42 to the inversion input terminal of the operational amplifier OP42 via the variable capacitor Cv42 and the variable capacitor Cv4l. In this manner, the first filter circuit 344 has the first feedback path FB1 and the second feedback path FB2, as feedback paths for feeding back the output signal of the operational amplifier OP42 to the inversion input terminal of the operational amplifier OP42.

The output signal of the operational amplifier OP42 is supplied to the first buffer circuit 346 as a first filter output signal Obpf1.

The first buffer circuit 346 is a buffer that converts an impedance to output the first inspection signal Vd1 having a low impedance. For example, the first buffer circuit 346 is configured with a voltage follower using an operational amplifier OP43. Therefore, the first filter output signal Obpf1 supplied to the first buffer circuit 346 is output from the first buffer circuit 346 as the first inspection signal Vd1 having a low impedance.

Next, a calculation equation of an amplification factor, a center frequency, and a Q value of the first filter circuit 344 will be described by using the amplification factor as H and the center frequency as f₀. The Q value is a parameter obtained by dividing the center frequency f₀ by a passband width. The passband width is, for example, a bandwidth defined by a frequency at which the amplification factor H is −3 dB.

A general transfer function of a band pass filter is represented by Equation (1) when a potential of an input signal is Vi, a potential of an output signal is Vo, and “2πf₀” is “ω₀”. In the following equation, “·” indicating multiplication is used as appropriate.

$$\frac{Vo}{Vi} = \frac{H \cdot \frac{{ω}_{0}}{Q}}{{S}^{2} + S \cdot \frac{{ω}_{0}}{Q} + {ω}_{0}^{2}} \qquad ( 1 )$$

In addition, a transfer function of the first filter circuit 344 is represented by Equation (2) when a potential of the first filter input signal INbpf1 is Vi and a potential of the first filter output signal Obpf1 is Vo. In the following equation, a resistance value of a resistor element and a capacitance value of a capacitor are represented by using a sign in which a number at an end of a sign of the element is a subscript. For example, “R₄₁”, “R₄₂”, and “R₄₃” in Equation (2) respectively indicate resistance values of the resistor element R41, the resistor element R42, and the variable resistor element Rv43, and “C₄₁” and “C₄₂” in Equation (2) respectively indicate capacitance values of the variable capacitors Cv41 and Cv42.

$$\frac{Vo}{Vi} = \frac{\frac{- 1}{{C}_{42} \cdot {R}_{41}} \cdot S}{{S}^{2} + S \cdot \frac{1}{{R}_{43}} \cdot ( \frac{1}{{C}_{41}} + \frac{1}{{C}_{42}} ) + \frac{1}{{C}_{41} \cdot {C}_{42} \cdot {R}_{43}} \cdot ( \frac{1}{{R}_{41}} + \frac{1}{{R}_{42}} )} \qquad ( 2 )$$

From Equations (1) and (2), the amplification factor H, the center frequency f₀, and the Q value of the first filter circuit 344 are represented by Equations (3), (4), and (5), respectively.

$$H = \frac{- 1}{\frac{{R}_{41}}{{R}_{43}} \cdot ( 1 + \frac{{C}_{42}}{{C}_{41}} )} \qquad ( 3 )$$

$$Q = \frac{1}{( ( \frac{{R}_{41} \cdot {R}_{42}}{{R}_{41} + {R}_{42}} ) \cdot \frac{1}{{R}_{43}} ) \cdot ( \sqrt{\frac{{C}_{41}}{{C}_{42}}} + \sqrt{\frac{{C}_{42}}{{C}_{41}}} )} \qquad ( 4 )$$

$${f}_{0} = \frac{1}{2 π \sqrt{{C}_{41} \cdot {C}_{42} \cdot ( \frac{{R}_{41} \cdot {R}_{42}}{{R}_{41} + {R}_{42}} ) \cdot {R}_{43}}} \qquad ( 5 )$$

Here, when the first filter circuit 344 is designed under the conditions of “C=C₄₁=C₄₂” and “R=R₄₁=R₄₂”, the amplification factor H, the center frequency f₀, and the Q value are respectively represented by Equations (6), (7), and (8) from Equations (3), (4), and (5).

$$H = \frac{- {R}_{43}}{2 R} \qquad ( 6 )$$

$$Q = \sqrt{\frac{{R}_{43}}{2 R}} \qquad ( 7 )$$

$${f}_{0} = \frac{1}{2 π \cdot C \sqrt{\frac{R \cdot {R}_{43}}{2}}} \qquad ( 8 )$$

From Equations (6) and (7), it is understood that the amplification factor H is determined by the resistance values of the resistor elements R41 and R42 and the resistance value of the variable resistor element Rv43, and the Q value is proportional to a positive square root of an absolute value of the amplification factor.

In the present embodiment, the amplification factor H and the Q value are adjusted by adjusting the resistance value of the variable resistor element Rv43. That is, in the present embodiment, an amplitude of the first filter output signal Obpf1 is adjusted by adjusting the resistance value of the variable resistor element Rv43. Therefore, an amplitude of the first inspection signal Vd1 indicating a pseudo residual vibration signal is adjusted. In this manner, in the present embodiment, the amplitude of the pseudo residual vibration signal is changed by adjusting the resistance value of the variable resistor element Rv43. Therefore, in the present embodiment, the amplitude of the pseudo residual vibration signal can be adjusted by adjusting the resistance value of the variable resistor element Rv43. For example, in the present embodiment, the amplitude of the pseudo residual vibration signal can be increased by increasing the resistance value of the variable resistor element Rv43. Alternatively, in the present embodiment, the amplitude of the pseudo residual vibration signal can be reduced by reducing the resistance value of the variable resistor element Rv43.

In the present embodiment, the center frequency f₀ is adjusted by adjusting the capacitance values of the variable capacitors Cv41 and Cv42. That is, in the present embodiment, a frequency of the first filter output signal Obpf1 is adjusted by adjusting the capacitance values of the variable capacitors Cv41 and Cv42. Therefore, a frequency of the first inspection signal Vd1 indicating a pseudo residual vibration signal is adjusted. That is, a cycle of the pseudo residual vibration signal is adjusted by adjusting the capacitance values of the variable capacitors Cv41 and Cv42. In this manner, in the present embodiment, the cycle of the pseudo residual vibration signal is changed by adjusting the capacitance values of the variable capacitors Cv41 and Cv42. Therefore, in the present embodiment, the cycle of the pseudo residual vibration signal can be adjusted by adjusting the capacitance values of the variable capacitors Cv41 and Cv42. For example, in the present embodiment, the cycle of the pseudo residual vibration signal can be increased by increasing the capacitance values of the variable capacitors Cv41 and Cv42. Alternatively, in the present embodiment, the cycle of the pseudo residual vibration signal can be reduced by reducing the capacitance values of the variable capacitors Cv41 and Cv42.

In the present embodiment, as described above, it is assumed that the resistance value of the resistor element R41 is equal to the resistance value of the resistor element R42, and the capacitance value of the variable capacitor Cv41 after adjustment is equal to the capacitance value of the variable capacitor Cv42 after adjustment. In this case, a design of the first filter circuit 344, the adjustment of the amplitude of the pseudo residual vibration signal, the adjustment of the cycle of the pseudo residual vibration signal, and the like can be prevented from being complicated. Here, “equal” is a concept including not only a case of being completely equal but also a case of being considered to be equal when an error is taken into consideration. The resistance value of the resistor element R41 may be different from the resistance value of the resistor element R42, and the capacitance value of the variable capacitor Cv41 after adjustment may be different from the capacitance value of the variable capacitor Cv42 after adjustment.

In addition, the configuration of the first inspection signal generation circuit 340 is not limited to the examples illustrated in FIGS. 7 and 9. For example, the first gain adjustment circuit 342 may be provided between the first filter circuit 344 and the first buffer circuit 346. Alternatively, some or all of the first gain adjustment circuit 342, the low-pass filter circuit 343, and the first buffer circuit 346 may be omitted from the first inspection signal generation circuit 340 illustrated in FIG. 9. In addition, both the resistor elements R41 and R42 may be variable resistor elements having an adjustable resistance value. When both of the resistor elements R41 and R42 are variable resistor elements, the first filter circuit 344 may have a resistor element having a non-adjustable resistance value, instead of the variable resistor element Rv43.

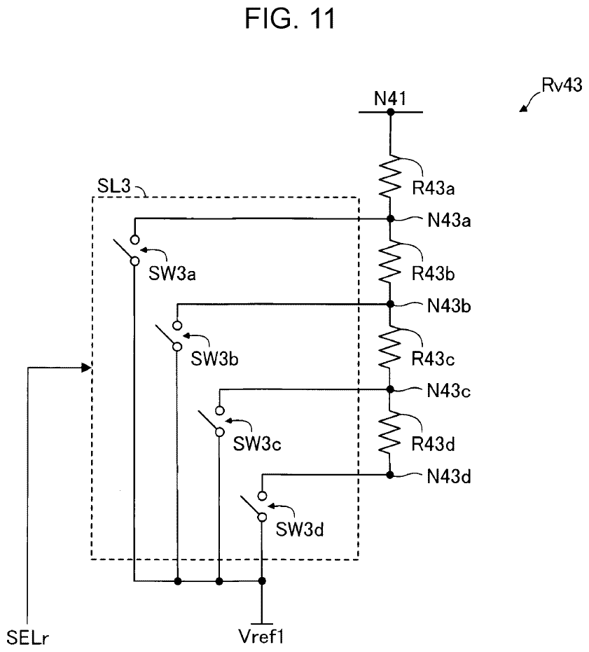

Next, the example of the configuration of the variable resistor element Rv43 will be described with reference to FIGS. 10 and 11. Meanwhile, a method of adjusting the resistance value of the variable resistor element Rv43 is not particularly limited to the method described with reference to FIGS. 10 and 11, and a known method can be adopted.

FIG. 10 is a circuit diagram illustrating the example of the configuration of the variable resistor element Rv43.

The variable resistor element Rv43 includes, for example, a plurality of resistor elements R43a, R43b, R43c, and R43d, and selecting sections SL1 and SL2. The selecting section SL1 has a plurality of switches SW1a, SW1b, SW1c, and SW1d that correspond to the plurality of resistor elements R43a, R43b, R43c, and R43d on a one-to-one basis. The selecting section SL2 has a plurality of switches SW2a, SW2b, SW2c, and SW2d that correspond to the plurality of resistor elements R43a, R43b, R43c, and R43d on a one-to-one basis. That is, the plurality of switches SW2a, SW2b, SW2c, and SW2d correspond to the plurality of switches SW1a, SW1b, SW1c, and SW1d on a one-to-one basis.

In the following, the resistor elements R43a, R43b, R43c, and R43d may be collectively referred to as a resistor element R43, the switches SW1a, SW1b, SW1c, and SW1d may be collectively referred to as a switch SW1, and the switches SW2a, SW2b, SW2c, and SW2d may be collectively referred to as a switch SW2. The number of resistor elements R43 included in the variable resistor element Rv43 is not limited to four. For example, the variable resistor element Rv43 may have two resistor elements R43 or may have three resistor elements R43. Alternatively, the variable resistor element Rv43 may have five or more resistor elements R43.

One end of each resistor element R43 is coupled to the node N41 via the switch SW1 corresponding to the resistor element R43, and the other end of each resistor element R43 is coupled to a wiring to which the first reference potential Vref1 is supplied via the switch SW2 corresponding to the resistor element R43. For example, one end of the resistor element R43a is coupled to the node N41 via the switch SW1a, and the other end of the resistor element R43a is coupled to the wiring to which the first reference potential Vref1 is supplied via the switch SW2a.

Each switch SW1 electrically couples the resistor element R43 corresponding to the switch SW1 and the node N41 by being turned on, and electrically decouples the resistor element R43 corresponding to the switch SW1 and the node N41 by being turned off. Further, each switch SW2 electrically couples the resistor element R43 corresponding to the switch SW1 and a wiring to which the first reference potential Vref1 is supplied by being turned on, and electrically decouples the resistor element R43 corresponding to the switch SW1 and the wiring to which the first reference potential Vref1 is supplied by being turned off. ON and OFF of each switch SW1 and ON and OFF of each switch SW2 are switched by the selection signal SELr. The switches SW1 and SW2 corresponding to each other are controlled by the selection signal SELr such that states of ON and OFF are the same as each other. For example, when the switch SW1a is turned on, the switch SW2a is also turned on, and when the switch SW1a is turned off, the switch SW2a is also turned off.

In this manner, in the example illustrated in FIG. 10, the resistor element R43 that electrically couples the node N41 and the wiring to which the first reference potential Vref1 is supplied is designated by the selection signal SELr. For example, when all of the plurality of switches SW1 and the plurality of switches SW2 are turned on, a plurality of resistor elements R43 are coupled in parallel between the node N41 and the wiring to which the first reference potential Vref1 is supplied. Resistance values of the plurality of resistor elements R43 may be the same resistance value, or the resistance values of a part or all of the plurality of resistor elements R43 may be different resistance values.

When the resistance values of the plurality of resistor elements R43 are the same as each other, the number of resistor elements R43 electrically coupling the node N41 and the wiring to which the first reference potential Vref1 is supplied to each other is adjusted by the selection signal SELr. In addition, when the resistance values of the plurality of resistor elements R43 are the same as each other, one of the plurality of resistor elements R43 may be electrically coupled to the node N41 without going through the switch SW1 and may be electrically coupled to the wiring to which the first reference potential Vref1 is supplied without going through the switch SW2.

In addition, when the resistance values of a part or all of the plurality of resistor elements R43 are different from each other, a combination of the resistor elements R43 that electrically couple the node N41 and the wiring to which the first reference potential Vref1 is supplied to each other is adjusted by the selection signal SELr. When the resistance values of a part or all of the plurality of resistor elements R43 are different from each other, the resistance value of the variable resistor element Rv43 can be adjusted in detail, as compared with a case where the resistance values of the plurality of resistor elements R43 are the same as each other. For example, a case where the resistance value of the resistor element R43b is half the resistance value of the resistor element R43a, the resistance value of the resistor element R43c is one third of the resistance value of the resistor element R43a, and the resistance value of the resistor element R43d is one fourth of the resistance value of the resistor element R43a is considered. In this case, by turning on the n switches SW1 and the n switches SW2 corresponding to the n switches SW1, the resistance value of the variable resistor element Rv43 can be set to a resistance value that cannot be set when the resistance values of the plurality of resistor elements R43 are the same as each other. The value n is a natural number of 2 or more and equal to or less than the number of the plurality of switches SW1.

The configuration of the variable resistor element Rv43 is not limited to the example illustrated in FIG. 10. For example, the selecting section SL1 may be omitted, and each resistor element R43 may be electrically coupled to the node N41 without going through the switch SW1. Alternatively, the selecting section SL2 may be omitted, and each resistor element R43 may be electrically coupled to the wiring to which the first reference potential Vref1 is supplied without going through the switch SW2. In addition, for example, in the aspect in which the selecting section SL2 is omitted, the switch SW1 coupled to one end of each resistor element R43 may be a switch that switches whether to couple one end of the resistor element R43 to the node N41 or to couple one end of the resistor element R43 to the wiring to which the first reference potential Vref1 is supplied. In addition, for example, the variable resistor element Rv43 may have the plurality of resistor elements R43 coupled in series as illustrated in FIG. 11.

FIG. 11 is a circuit diagram illustrating another example of the configuration of the variable resistor element Rv43.

The variable resistor element Rv43 includes, for example, the plurality of resistor elements R43a, R43b, R43c, and R43d coupled in series between the node N41 and the node N43d, and a selecting section SL3. The selecting section SL3 has a plurality of switch SW3a, SW3b, SW3c, and SW3d that correspond to the plurality of resistor elements R43a, R43b, R43c, and R43d on a one-to-one basis. In the following, the switches SW3a, SW3b, SW3c, and SW3d may be collectively referred to as a switch SW3. The number of resistor elements R43 included in the variable resistor element Rv43 is not limited to four. For example, the variable resistor element Rv43 may have two resistor elements R43 coupled in series, or may have three resistor elements R43 coupled in series. Alternatively, the variable resistor element Rv43 may have five or more resistor elements R43 coupled in series.

For example, among the plurality of resistor elements R43 coupled in series between the node N41 and the node N43d, the resistor element R43a is coupled to the node N41 and the resistor element R43d is coupled to the node N43d. The node N43a is a coupling node between the resistor element R43a and the resistor element R43b, the node N43b is a coupling node between the resistor element R43b and the resistor element R43c, and the node N43c is a coupling node between the resistor element R43c and the resistor element R43d.

One end of the switch SW3a is coupled to the node N43a, and the other end of the switch SW3a is coupled to a wiring to which the first reference potential Vref1 is supplied. One end of the switch SW3b is coupled to the node N43b, and the other end of the switch SW3b is coupled to the wiring to which the first reference potential Vref1 is supplied. One end of the switch SW3c is coupled to the node N43c, and the other end of the switch SW3c is coupled to the wiring to which the first reference potential Vref1 is supplied. One end of the switch SW3d is coupled to the node N43d, and the other end of the switch SW3d is coupled to the wiring to which the first reference potential Vref1 is supplied.

ON and OFF of each switch SW3 is switched by the selection signal SELr. In the example illustrated in FIG. 11, only one of the plurality of switches SW3 is controlled to be turned on by the selection signal SELr. For example, when the switch SW3a is turned on, the switches SW3b, SW3c, and SW3d other than the switch SW3a are turned off. In this case, a resistance value of the variable resistor element Rv43 is a resistance value based on a resistance value of the resistor element R43a.

In this manner, in the example illustrated in FIG. 11, whether the node N41 and the wiring to which the first reference potential Vref1 is supplied are electrically coupled to each other by the resistor element R43a or are electrically coupled to each other by the plurality of resistor elements R43 coupled in series is designated by the selection signal SELr. In addition, when the plurality of resistor elements R43 coupled in series are electrically coupled between the node N41 and the wiring to which the first reference potential Vref1 is supplied, the number of resistor elements R43 coupled in series is adjusted by the selection signal SELr. The resistance values of the plurality of resistor elements R43 may be the same resistance value, or the resistance values of a part or all of the plurality of resistor elements R43 may be different resistance values.

The configuration of the variable resistor element Rv43 is not limited to the example illustrated in FIG. 11. For example, the switch SW3d may be omitted, and the resistor element R43d may be electrically coupled to the wiring to which the first reference potential Vref1 is supplied without going through the switch SW3d. In the aspect in which the switch SW3d is omitted, an on-resistance, which is a resistance value of the switch SW3 when each switch SW3 is turned on, is preferably small to be negligible as compared with a resistance value of the resistor element R43. Therefore, for example, when the switch SW3c is turned on, a combined resistance of a circuit in which the switch SW3c and the resistor element R43d are coupled in parallel becomes a resistance value substantially the same as the on-resistance of the switch SW3c. Therefore, even in the aspect in which the switch SW3d is omitted, the resistance value of the variable resistor element Rv43 is adjusted by the selection signal SELr as in the example illustrated in FIG. 11.

In the present embodiment, the resistance value of the variable resistor element Rv43 can be set by using the selection signal SELr such that an amplitude of a pseudo residual vibration signal generated by the first inspection signal generation circuit 340 in the ejection state determination process becomes an appropriate amplitude. The resistance value of the variable resistor element Rv43 may be set in advance by a manufacturer of the head unit 3 or the like, or may be executed by the drive control section 22 or the like based on operation information indicating a content of the operation performed on the ink jet printer 1. The setting of the resistance value of the variable resistor element Rv43 is also regarded as setting of the selection signal SELr.

Next, an example of a configuration of the variable capacitor Cv41 will be described with reference to FIG. 12. Although the variable capacitor Cv42 is not particularly described in FIG. 12, the variable capacitor Cv42 may be configured in the same manner as the variable capacitor Cv41, for example. A method of adjusting the capacitance values of the variable capacitors Cv41 and Cv42 is not particularly limited to the method described with reference to FIG. 12, and a known method can be adopted.

FIG. 12 is a circuit diagram illustrating the example of the configuration of the variable capacitor Cv41.

The variable capacitor Cv41 has, for example, a plurality of capacitors C41a, C41b, C41c, and C41d, and selecting sections SL4 and SL5. The selecting section SL4 has a plurality of switches SW4a, SW4b, SW4c, and SW4d corresponding to the plurality of capacitors C41a, C41b, C41c, and C41d on a one-to-one basis. The selecting section SL5 has a plurality of switches SW5a, SW5b, SW5c, and SW5d corresponding to the plurality of capacitors C41a, C41b, C41c, and C41d on a one-to-one basis. That is, the plurality of switches SW5a, SW5b, SW5c, and SW5d correspond to the plurality of switches SW4a, SW4b, SW4c, and SW4d on a one-to-one basis.

Hereinafter, the capacitors C41a, C41b, C41c, and C41d may be collectively referred to as a capacitor C41, the switches SW4a, SW4b, SW4c, and SW4d may be collectively referred to as a switch SW4, and the switches SW5a, SW5b, SW5c, and SW5d may be collectively referred to as a switch SW5. The number of the capacitors C41 included in the variable capacitor Cv41 is not limited to four. For example, the variable capacitor Cv41 may have two capacitors C41 or may have three capacitors C41. Alternatively, the variable capacitor Cv41 may have five or more capacitors C41.

One end of each capacitor C41 is coupled to the node N41 via the switch SW4 corresponding to the capacitor C41, and the other end of each capacitor C41 is coupled to an inversion input terminal of the operational amplifier OP42 via the switch SW5 corresponding to the capacitor C41. For example, one end of the capacitor C41a is coupled to the node N41 via the switch SW4a, and the other end of the capacitor C41a is coupled to the inversion input terminal of the operational amplifier OP42 via the switch SW5a.

Each switch SW4 electrically couples the capacitor C41 corresponding to the switch SW4 and the node N41 by being turned on, and electrically decouples the capacitor C41 corresponding to the switch SW4 and the node N41 by being turned off. Further, each switch SW5 electrically couples the capacitor C41 corresponding to the switch SW4 and the inversion input terminal of the operational amplifier OP42 by being turned on, and electrically decouples the capacitor C41 corresponding to the switch SW4 and the inversion input terminal of the operational amplifier OP42 by being turned off. ON and OFF of each switch SW4 and ON and OFF of each switch SW5 are switched by the selection signal SELc1. The switches SW4 and SW5 corresponding to each other are controlled by the selection signal SELc1 such that states of ON and OFF are the same as each other. For example, when the switch SW4a is turned on, the switch SW5a is also turned on, and when the switch SW4a is turned off, the switch SW5a is also turned off.

In this manner, in the example illustrated in FIG. 12, the capacitor C41 through which the AC signal passes between the node N41 and the inversion input terminal of the operational amplifier OP42 is designated by the selection signal SELc1. For example, when all of the plurality of switches SW4 and the plurality of switches SW5 are turned on, the plurality of capacitors C41 are coupled in parallel between the node N41 and the inversion input terminal of the operational amplifier OP42. The capacitance values of the plurality of capacitors C41 may be the same capacitance value, or the capacitance values of a part or all of the plurality of capacitors C41 may be different capacitance values.

When the capacitance values of the plurality of capacitors C41 are the same as each other, the number of capacitors C41 through which the AC signal passes between the node N41 and the inversion input terminal of the operational amplifier OP42 is adjusted by the selection signal SELc1. In addition, when the capacitance values of the plurality of capacitors C41 are the same as each other, one of the plurality of capacitors C41 may be electrically coupled to the node N41 without going through the switch SW4 and electrically coupled to the inversion input terminal of the operational amplifier OP42 without going through the switch SW5.

In addition, when the capacitance values of a part or all of the plurality of capacitors C41 are different from each other, the combination of the capacitors C41 through which the AC signal passes between the node N41 and the inversion input terminal of the operational amplifier OP42 is adjusted by the selection signal SELc1. When the capacitance values of a part or all of the plurality of capacitors C41 are different from each other, the capacitance value of the variable capacitor Cv41 can be adjusted in detail as compared with a case where the capacitance values of the plurality of capacitors C41 are the same as each other. For example, a case where the capacitance value of the capacitor C41b is twice the capacitance value of the capacitor C41a, the capacitance value of the capacitor C41c is three times the capacitance value of the capacitor C41a, and the capacitance value of the capacitor C41d is four times the capacitance value of the capacitor C41a is considered. In this case, by turning on the n switches SW4 and the n switches SW5 corresponding to the n switches SW4, the capacitance value of the variable capacitor Cv41 can be set to a capacitance value that cannot be set when the capacitance values of the plurality of capacitors C41 are the same as each other. The value n is a natural number of 2 or more and equal to or less than the number of the plurality of switches SW4.

The configuration of the variable capacitor Cv41 is not limited to the example illustrated in FIG. 12. For example, the selecting section SL4 may be omitted, and each capacitor C41 may be electrically coupled to the node N41 without going through the switch SW4. Alternatively, the selecting section SL5 may be omitted, and each capacitor C41 may be electrically coupled to the inversion input terminal of the operational amplifier OP42 without going through the switch SW5. In addition, for example, the variable capacitor Cv41 may have the plurality of capacitors C41 coupled in series, in the same manner as in the configuration of the variable resistor element Rv43 illustrated in FIG. 11.

In the present embodiment, in the ejection state determination process, the capacitance values of the variable capacitors Cv41 and Cv42 can be respectively set by using the selection signals SELc1 and SELc2 such that the cycle of the pseudo residual vibration signals generated by the first inspection signal generation circuit 340 becomes an appropriate cycle. The capacitance values of the variable capacitors Cv41 and Cv42 may be set in advance by the manufacturer of the head unit 3 or may be executed by the drive control section 22 or the like based on operation information indicating the content of the operation performed on the ink jet printer 1. The setting of the capacitance values of the variable capacitors Cv41 and Cv42 is also regarded as setting of the selection signals SELc1 and SELc2.

Next, an outline of the second inspection signal generation circuit 350 will be described with reference to FIG. 13.

FIG. 13 is a circuit diagram illustrating an example of a configuration of the second inspection signal generation circuit 350.

As described in FIG. 7, the second inspection signal generation circuit 350 includes the second gain adjustment circuit 352, the second filter circuit 354, and the second buffer circuit 356.

The second gain adjustment circuit 352 is a negative feedback type amplifier configured in the same manner as the first gain adjustment circuit 342 illustrated in FIG. 9. For example, the second gain adjustment circuit 352 includes an operational amplifier OP50 that receives the second input signal Vs2 supplied from the second switching circuit 337 at a non-inversion input terminal, and a variable resistor RV2 that divides an output signal of the operational amplifier OP50 and feeds back the divided output signal to an inversion input terminal of the operational amplifier OP50. One end of the variable resistor RV2 is coupled to an output terminal of the operational amplifier OP50, the other end of the variable resistor RV2 is coupled to a wiring to which the second reference potential Vref2 is supplied, and a moving contact of the variable resistor RV2 is coupled to the inversion input terminal of the operational amplifier OP50. The second gain adjustment circuit 352 can output a second filter input signal INbpf2 obtained by adjusting an amplitude of the second input signal Vs2 to the second filter circuit 354 by adjusting a position of the moving contact of the variable resistor RV2, for example.

The second filter circuit 354 is, for example, a band pass filter including resistor elements R51 and R52, capacitors C51 and C52, and an operational amplifier OP51, and passes a signal of a predetermined frequency component.

One end of the resistor element R51 is coupled to the output terminal of the operational amplifier OP50 of the second gain adjustment circuit 352, the other end of the resistor element R51 is coupled to one end of the capacitor C51, and the other end of the capacitor C51 is coupled to an inversion input terminal of the operational amplifier OP51. One end of the capacitor C52 is coupled to the inversion input terminal of the operational amplifier OP51, and the other end of the capacitor C52 is coupled to an output terminal of the operational amplifier OP51. One end of the resistor element R52 is coupled to the inversion input terminal of the operational amplifier OP51, and the other end of the resistor element R52 is coupled to the output terminal of the operational amplifier OP51. In addition, a non-inversion input terminal of the operational amplifier OP51 is coupled to the wiring to which the second reference potential Vref2 is supplied.

For example, the second filter input signal INbpf2 is input to the inversion input terminal of the operational amplifier OP51 via the resistor element R51 and the capacitor C51. That is, the second input signal Vs2 is input to the inversion input terminal of the operational amplifier OP51 via the second gain adjustment circuit 352, the resistor element R51, and the capacitor C51. An output signal of the operational amplifier OP41 is fed back to an inversion input terminal of the operational amplifier OP41 by a feedback path in which the resistor element R52 and the capacitor C52 are coupled in parallel.

An output signal of the operational amplifier OP51 is supplied to the second buffer circuit 356 as a second filter output signal Obpf2.

The second buffer circuit 356 is a buffer that converts an impedance to output the second inspection signal Vd2 having a low impedance. For example, the second buffer circuit 356 is configured with a voltage follower using an operational amplifier OP52, in the same manner as the first buffer circuit 346 illustrated in FIG. 9. Therefore, the second filter output signal Obpf2 supplied to the second buffer circuit 356 is output from the second buffer circuit 356 as the second inspection signal Vd2 having a low impedance.

Next, a calculation equation of a low-pass cutoff frequency, a high-pass cutoff frequency, and an amplification factor of the second filter circuit 354 will be described by using the low-pass cutoff frequency as f_{LPF}, the high-pass cutoff frequency as f_{HPF}, and the amplification factor as G.

The cutoff frequency f_{LPF} of the second filter circuit 354 is a cutoff frequency of a low-pass filter configured with the capacitor C52 and the resistor element R52, and is represented by Equation (9). The cutoff frequency f_{HPF} of the second filter circuit 354 is a cutoff frequency of a high-pass filter configured with the capacitor C51 and the resistor element R51, and is represented by Equation (10).

$${f}_{LPF} = \frac{1}{2 π \cdot {C}_{52} \cdot {R}_{52}} \qquad ( 9 )$$

$${f}_{HPF} = \frac{1}{2 π \cdot {C}_{51} \cdot {R}_{51}} \qquad ( 10 )$$

The amplification factor G of the second filter circuit 354 is represented by Equation (11), Equation (12), and Equation (13). An angular frequency ω[rad] in Equations (12) and (13) indicates an angular frequency corresponding to a center frequency of the second filter circuit 354 that functions as a band pass filter.

$$G = \frac{{Z}_{2}}{{Z}_{1}} \qquad ( 11 )$$

$${Z}_{1} = \sqrt{{( {R}_{51} )}^{2} + {( \frac{1}{ω \cdot {C}_{51}} )}^{2}} \qquad ( 12 )$$

$${Z}_{2} = \frac{{R}_{52}}{\sqrt{1 + {ω}^{2} \cdot {( {C}_{52} )}^{2} \cdot {( {R}_{52} )}^{2}}} \qquad ( 13 )$$

The configuration of the second inspection signal generation circuit 350 is not limited to the examples illustrated in FIGS. 7 and 13. For example, the second gain adjustment circuit 352 may be provided between the second filter circuit 354 and the second buffer circuit 356. Alternatively, a part or all of the second gain adjustment circuit 352 and the second buffer circuit 356 may be omitted from the second inspection signal generation circuit 350 illustrated in FIG. 13.

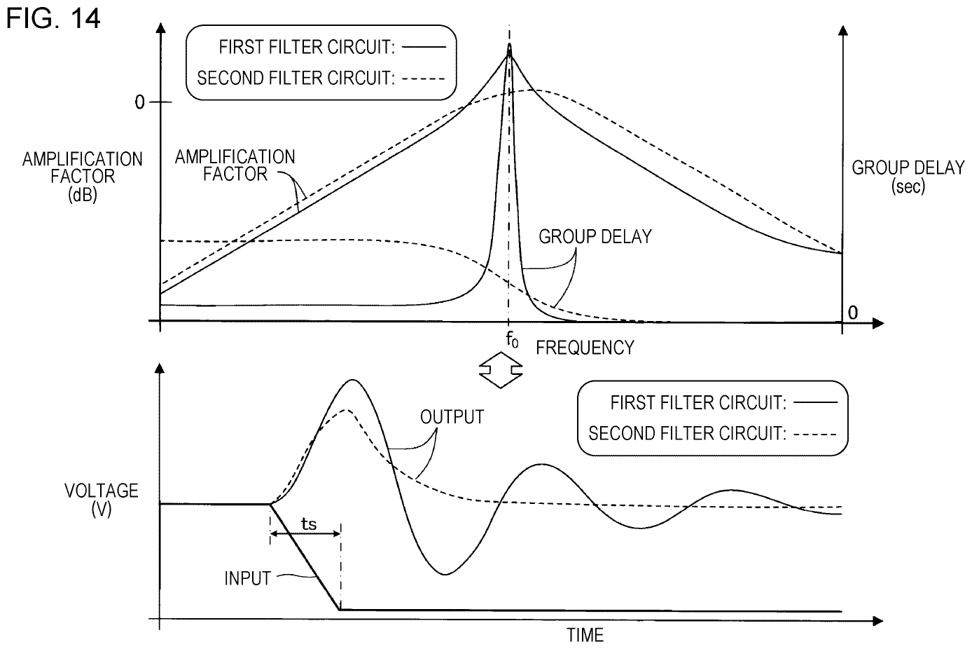

Next, characteristics of the first filter circuit 344 will be described with reference to FIG. 14.

FIG. 14 is an explanatory diagram describing the characteristics of the first filter circuit 344. An upper part in FIG. 14 illustrates a relationship between an amplification factor and a group delay, and a frequency of the first filter circuit 344. In addition, a lower part in FIG. 14 illustrates a response of the first filter circuit 344 having the characteristics illustrated in the upper part in FIG. 14 when a signal changed from a high level to a low level is input to the first filter circuit 344. In FIG. 14, characteristics and the like of the second filter circuit 354 are illustrated by broken lines as a comparison target of the first filter circuit 344.

As described in FIG. 9, the first filter circuit 344 is a multiplex feedback type band pass filter. As illustrated in the upper part in FIG. 14, the multiplex feedback type band pass filter has a characteristic in which a group delay is changed greatly in the vicinity of the center frequency f₀. The delay occurring in the vicinity of the center frequency f₀ means that a phase rotates in the vicinity of the center frequency f₀. For example, the group delay characteristic is represented by “Tdg(ω)=−dφ/dω” when the group delay is Tdg, the phase is φ[rad], and an angular velocity is ω[rad/sec].

In the first filter circuit 344 in which the group delay is largely changed in the vicinity of the center frequency f₀, overshoot occurs at the center frequency f₀. That is, an attenuation vibration waveform is generated at the center frequency f₀. Therefore, in the first filter circuit 344, as illustrated in the lower part in FIG. 14, even when the input signal is maintained at a low-level potential, a signal having an attenuation vibration waveform is output.

On the other hand, the second filter circuit 354 does not have a characteristic in which the group delay is changed greatly in the vicinity of the center frequency f₀ as illustrated by the broken line in the upper part in FIG. 14. In the second filter circuit 354, as illustrated by the broken line in the lower part in FIG. 14, when the input signal is maintained at the low-level potential, the output signal converges to a predetermined potential.

In the present embodiment, the attenuation vibration waveform generated at the center frequency f₀ is made to approach a sine wave, so that the first filter output signal Obpf1, which is the output signal of the first filter circuit 344, can be treated as a pseudo residual vibration signal that emulates residual vibration of the ejecting section D. Here, a time ts illustrated in FIG. 14 is a time until the potential of the first filter input signal INbpf1 input to the first filter circuit 344 is changed from the maximum value to the minimum value. For example, in order to generate an attenuation vibration waveform close to a sine wave, the center frequency f₀ is designed to be equal to or less than “1/(2 ts)”.

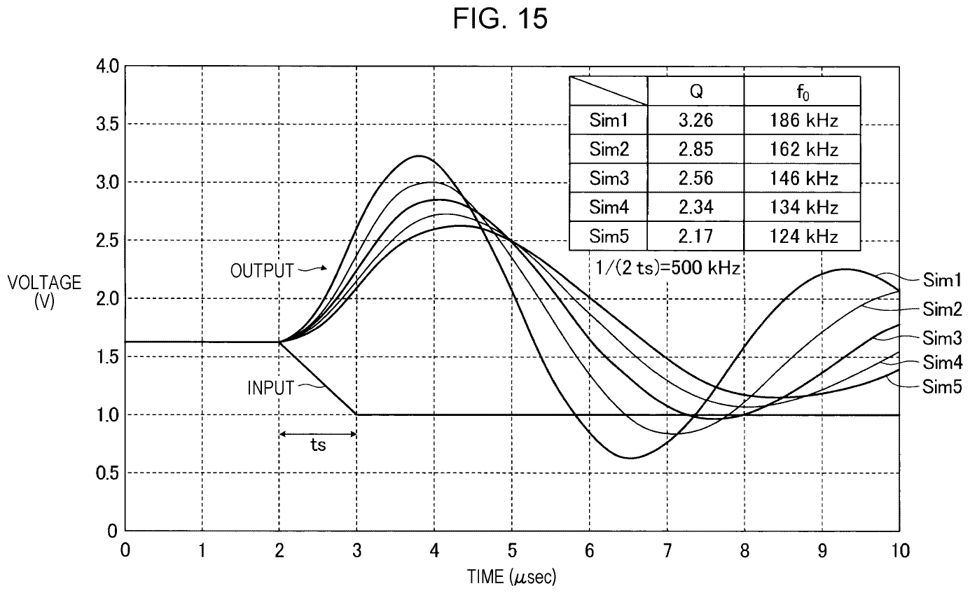

Next, a simulation result of the first filter circuit 344 will be described with reference to FIG. 15.

FIG. 15 is a diagram illustrating a simulation result of the first filter circuit 344. FIG. 15 illustrates a simulation result of a response of the first filter circuit 344 when a signal changed from a high level to a low level is input. In the simulation illustrated in FIG. 15, a time ts until a potential of a signal input to the first filter circuit 344 is changed from the maximum value to the minimum value is 1 psec, and “1/(2 ts)” is 500 kHz.

In addition, a simulation result Sim1 indicates a simulation result of the first filter circuit 344 when a Q value is 3.26 and a center frequency f₀ is 186 kHz. A simulation result Sim2 illustrates a simulation result of the first filter circuit 344 when the Q value is 2.85 and the center frequency f₀ is 162 kHz. A simulation result Sim3 illustrates a simulation result of the first filter circuit 344 when the Q value is 2.56 and the center frequency f₀ is 146 kHz. A simulation result Sim4 illustrates a simulation result of the first filter circuit 344 when the Q value is 2.34 and the center frequency f₀ is 134 kHz. A simulation result Sim5 illustrates a simulation result of the first filter circuit 344 when the Q value is 2.17 and the center frequency f₀ is 124 kHz.

As illustrated in FIG. 15, when the center frequency f₀ is equal to or less than “1/(2 ts)”, an output signal of the first filter circuit 344 becomes close to a sine wave. Although not illustrated in FIG. 15, when the center frequency f₀ is “1/ts”, a simulation result is checked in which a distortion occurs at the output signal of the first filter circuit 344 and the output signal of the first filter circuit 344 cannot be regarded as a sine wave.

Here, the Q value is adjusted by adjusting the resistance value of the variable resistor element Rv43 as illustrated in Equation (7) described above. In addition, the center frequency f₀ is adjusted by adjusting one or both of the capacitance values of the variable capacitors Cv41 and Cv42 and the resistance value of the variable resistor element Rv43 as illustrated in Equation (8) described above. For example, the resistance value of the variable resistor element Rv43 is adjusted such that an amplitude of a pseudo residual vibration signal generated by the first inspection signal generation circuit 340 in the ejection state determination process has an appropriate amplitude. Then, in a state in which the resistance value of the variable resistor element Rv43 is maintained at the resistance value after adjustment, the capacitance values of the variable capacitors Cv41 and Cv42 are adjusted such that a cycle of the pseudo residual vibration signal generated by the first inspection signal generation circuit 340 in the ejection state determination process becomes an appropriate cycle.

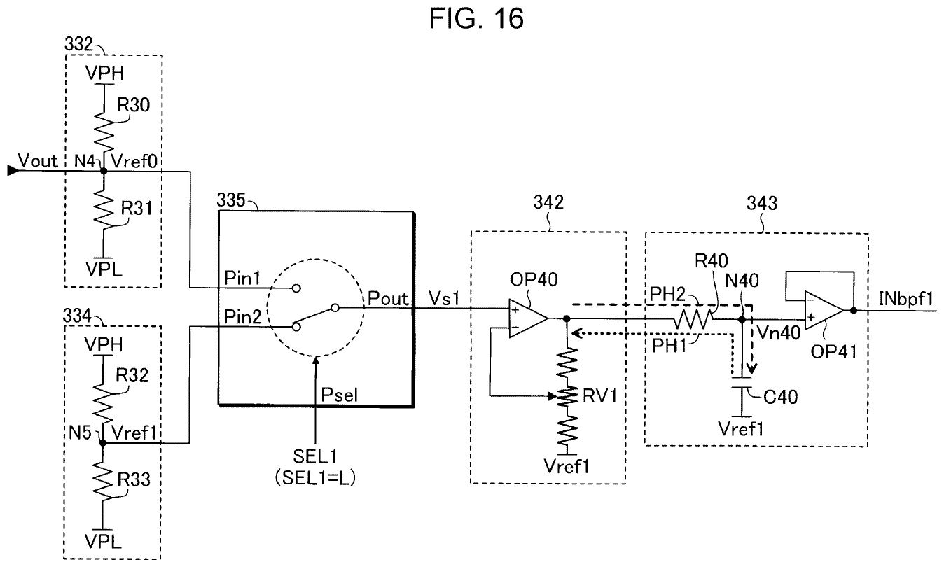

Next, the operation of the low-pass filter circuit 343 when the first input signal Vs1 is switched from the detection signal Vout to the first reference potential Vref1 will be briefly described with reference to FIG. 16.

FIG. 16 is an explanatory diagram describing an operation of the low-pass filter circuit 343 when the first input signal Vs1 is switched from the detection signal Vout to the first reference potential Vref1.

For example, at a detection end time at which the first input signal Vs1 is switched from the detection signal Vout to the first reference potential Vref1, a potential Vn40 of the node N40 is held at a potential of an output signal of the operational amplifier OP40 at the detection end time by the capacitor C40. The potential Vn40 of the node N40 converges to the first reference potential Vref1 with a time constant of the low-pass filter circuit 343. For example, when the potential Vn40 of the node N40 at the detection end time is higher than the first reference potential Vref1, the capacitor C40 is discharged to the first gain adjustment circuit 342 through the first path PH1. In addition, for example, when the potential Vn40 of the node N40 at the detection end time is lower than the first reference potential Vref1, the capacitor C40 is charged from the first gain adjustment circuit 342 through the second path PH2.

The potential Vn40 of the node N40 in and after the detection end time is represented by Equation (14), by using the first reference potential Vref1, an elapsed time t from the detection end time, a time constant T, and a potential difference ΔVn40 between the potential Vn40 at the detection end time and the first reference potential Vref1.

$$Vn 40 = Δ Vn 40 \cdot exp ( - t / τ ) + Vref 1 \qquad ( 14 )$$

In addition, “exp( )” in Equation (14) indicates an exponential function. The potential difference ΔVn40 of Equation (14) is represented by Equation (15), for example, by using the potential Vn40 at the detection end time and the first reference potential Vref1.

ΔVn40=Vn40−Vref1 (15)

Further, when an output impedance of a circuit in the previous stage of the low-pass filter circuit 343 is Rp, the time constant T of Equation (14) is represented by Equation (16). In the present embodiment, since the circuit in the preceding stage of the low-pass filter circuit 343 is the first gain adjustment circuit 342, the output impedance Rp in Equation (16) indicates an output impedance of the first gain adjustment circuit 342.

$$τ = {C}_{40} \cdot ( {R}_{40} + Rp ) \qquad ( 16 )$$

When an output impedance of the operational amplifier OP40 is very small as compared with an impedance of the variable resistor RV1, the output impedance of the operational amplifier OP40 may be regarded as the output impedance of the first gain adjustment circuit 342.

In addition, for example, in a configuration in which the low-pass filter circuit 343 is coupled to the first switching circuit 335 without going through the first gain adjustment circuit 342, the output impedance Rp of Equation (16) indicates the output impedance of the first reference potential generation circuit 334. In this case, the output impedance Rp is represented by Equation (17).

$$Rp = ( {R}_{32} \cdot {R}_{33} ) / ( {R}_{32} + {R}_{33} ) \qquad ( 17 )$$

In addition, for example, it is preferable that the low-pass filter circuit 343 is designed such that a relationship between the time ts until a potential of the detection signal Vout input to the first inspection signal generation circuit 340 as the first input signal Vs1 reaches the minimum value from the maximum value and the time constant τ satisfies Equation (18).

$$ts / 2 \approx τ ∼ 4.6 τ \qquad ( 18 )$$

The “τ” in Equation (18) corresponds to a time until the charging or discharging of the capacitor C40 reaches substantially 63%, and the “4.6τ” in Equation (18) corresponds to a time until the charging or discharging of the capacitor C40 reaches substantially 100%. Therefore, Equation (18) means that a range of a time from a time when charging or discharging of the capacitor C40 reaches substantially 63% to a time when the charging or discharging of the capacitor C40 reaches approximately 100% includes half the time ts.

Here, in the first filter circuit 344 in the subsequent stage of the low-pass filter circuit 343, a circuit including the variable capacitor Cv41, the resistor element R42, and the operational amplifier OP42 functions as a differential circuit. Therefore, when a noise is superimposed on the detection signal Vout input to the first inspection signal generation circuit 340 or when the detection signal Vout includes a steep potential change, a distortion may occur at the first filter output signal Obpf1 output from the first filter circuit 344. When the distortion occurs in the first filter output signal Obpf1, a variation in amplitude value of the first inspection signal Vd1 generated as a pseudo residual vibration signal becomes large, and determination accuracy of the state of the ejecting section D may be lowered. Therefore, in the present embodiment, a potential of the first input signal Vs1 in a non-detection period, which is a period in which the detection signal Vout is not input to the first inspection signal generation circuit 340, is stabilized, and thus, the occurrence of the distortion in the first filter output signal Obpf1 is suppressed. Specifically, in the present embodiment, the first switching circuit 335 and the low-pass filter circuit 343 suppress the occurrence of distortion in the first filter output signal Obpf1 by making the potential of the first input signal Vs1 in the non-detection period converge to the first reference potential Vref1.

Next, effects of the first switching circuit 335 and the low-pass filter circuit 343 will be described with reference to FIG. 17.

FIG. 17 is an explanatory diagram describing the effects of the first switching circuit 335 and the low-pass filter circuit 343. The “with countermeasure for distortion” in FIG. 17 illustrates a simulation result of the first filter circuit 344 when the first switching circuit 335 and the low-pass filter circuit 343 are provided in a preceding stage of the first filter circuit 344. Further, “comparative example” in FIG. 17 illustrates a simulation result of the first filter circuit 344 when the first switching circuit 335 and the low-pass filter circuit 343 are not provided in the preceding stage of the first filter circuit 344. Meanwhile, in the comparative example, a switch that simply switches whether or not to electrically couple the switching circuit 31 and the detection circuit 33 is provided instead of the first switching circuit 335.

As illustrated in FIG. 17, in the comparative example in which the first switching circuit 335 and the low-pass filter circuit 343 are not provided, a noise is generated in the first filter input signal INbpf1 in a period before the detection period Tdet1 starts. In the comparative example, a potential of the first filter input signal INbpf1 is changed rapidly at an end of the detection period Tdet1. Therefore, in the comparative example, a distortion occurs in the first filter output signal Obpf1 in the period before the detection period Tdet1 starts and at the end of the detection period Tdet1.

On the other hand, in the configuration in which the first switching circuit 335 and the low-pass filter circuit 343 are provided, the noise generated in the first filter input signal INbpf1 and the rapid change in the potential of the first filter input signal INbpf1 are suppressed. As a result, in the configuration in which the first switching circuit 335 and the low-pass filter circuit 343 are provided, the occurrence of the distortion in the first filter output signal Obpf1 is suppressed.

In this manner, in the present embodiment, the distortion of the first filter output signal Obpf1 is suppressed, and thus a variation in the amplitude value of the first inspection signal Vd1 generated as a pseudo residual vibration signal can be suppressed. As a result, in the present embodiment, a state of the ejecting section D can be accurately determined.

Further, as illustrated in FIG. 17, the first filter circuit 344 can output the first filter output signal Obpf1 having one cycle or more, based on the first filter input signal INbpf1 having ¼ cycle or more and less than one cycle.

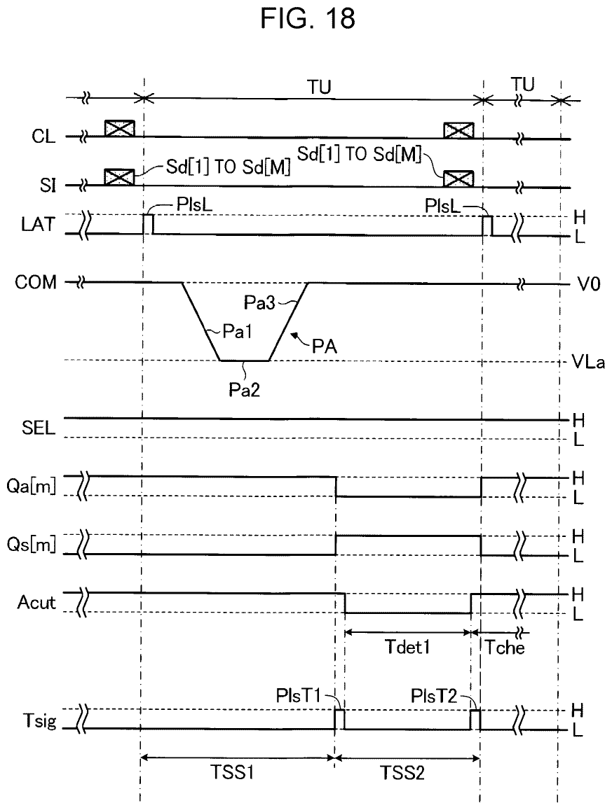

Next, an operation of the ink jet printer 1 will be described with reference to FIG. 18.

FIG. 18 is a timing chart illustrating an example of an operation of the ink jet printer 1 during a unit period TU. In the present embodiment, when the ink jet printer 1 executes a printing process or an ejection state determination process, one or a plurality of unit periods TU are set as an operation period of the ink jet printer 1. The ink jet printer 1 according to the present embodiment can drive each ejecting section D[m] for the printing process or the ejection state determination process in each unit period TU. For example, when executing the ejection state determination process, the ink jet printer 1 can drive the determination target ejecting section D and detect the detection signal Vout[m] from the determination target ejecting section D in each unit period TU.

The control unit 2 outputs the latch signal LAT having a pulse PlsL. Therefore, the control unit 2 defines the unit period TU as a period from rising of the pulse PlsL to rising of the next pulse PlsL.

The print signal SI includes, for example, M individual designation signals Sd[1] to Sd[M] corresponding to the M ejecting sections D[1] to D[M] on a one-to-one basis. The individual designation signal Sd[m] designates an aspect of driving the ejecting section D[m] in each unit period TU when the ink jet printer 1 executes the printing process or the ejection state determination process. For example, the control unit 2 supplies the print signal SI including the individual designation signals Sd[1] to Sd[M] to the coupling state designation circuit 310 in synchronization with a clock signal CL before each unit period TU. The coupling state designation circuit 310 generates the coupling state designation signals Qa[m] and Qs[m] based on the individual designation signal Sd[m] in the unit period TU. Further, the coupling state designation circuit 310 generates the selection signal SEL and the detection period signal Acut based on at least some signals of the print signal SI, the latch signal LAT, and the period defining signal Tsig.

For example, by the individual designation signal Sd[m], the ejecting section D[m] is designated to any one of the ejecting section D that forms dots and the ejecting section D that does not form dots in the unit period TU in which the printing process is executed. Further, for example, by the individual designation signal Sd[m], the ejecting section D[m] is designated as to whether or not the determination target ejecting section D is driven in the unit period TU in which the ejection state determination process is executed. In FIG. 18, in the unit period TU during which the ejection state determination process is executed, the coupling state designation signals Qa[m] and Qs[m] and the like when the ejecting section D[m] is designated as the determination target ejecting section D by the individual designation signal Sd[m] are illustrated. In FIG. 18, the operation of the ink jet printer 1 when executing the ejection state determination process will be mainly described.

When executing the ejection state determination process, for example, the control unit 2 outputs the period defining signal Tsig having a pulse PlsT1 and a pulse PlsT2. Therefore, the control unit 2 divides the unit period TU into a control period TSS1 from a start of the pulse PlsL to a start of the pulse PlsT1 and a control period TSS2 from a start of the pulse PlsT1 to a start of the next pulse PlsL.

Further, the coupling state designation circuit 310 defines the detection period Tdet1 of the detection signal Vout[m] by controlling the detection period signal Acut. For example, the coupling state designation circuit 310 sets the detection period signal Acut to a low level with an end of the pulse PlsT1 as a trigger, and sets the detection period signal Acut to a high level with a start of the pulse PlsT2 as a trigger. A time from a start to an end of the detection period Tdet1 corresponds to a time assigned to the detection of the residual vibration of the ejecting section D. In FIG. 18, the detection period Tdet1 when the detection signal Vout[m] is supplied to the first inspection signal generation circuit 340 is illustrated. When the detection signal Vout[m] is supplied to the first inspection signal generation circuit 340, a pseudo residual vibration signal obtained by emulating residual vibration of the ejecting section D[m] is generated in an inspection period Tche. In FIG. 18, it is assumed that the detection signal Vout[m] is supplied to the first inspection signal generation circuit 340, and thus the selection signal SEL is maintained at a high level.

The drive signal COM used in the ejection state determination process has, for example, a pulse PA supplied to the wiring La in the control period TSS1. The pulse PA used for the ejection state determination process may be a pulse with which an ink is not ejected from the nozzle N even when the pulse is a pulse that generates vibration in the diaphragm 321, or may be a pulse with which the ink is ejected from the nozzle N. In the present embodiment, it is assumed that the pulse PA is a pulse with which the ink is not ejected from the nozzle N. In the printing process, a pulse for ejecting the ink from the nozzle N is supplied to the wiring La in the unit period TU instead of the pulse PA.

The pulse PA is a waveform in which a potential of the drive signal COM is changed from a potential V0 to the potential V0 via the potential VLa lower than the potential V0. The potential V0 is a potential at a start and an end of the pulse PA, and is a reference potential of the drive signal COM.

For example, the pulse PA has a waveform element Pa1 in which a potential is changed from the potential V0 to the potential VLa, a waveform element Pa2 in which the potential is maintained at the potential VLa at an end of the waveform element Pa1, and a waveform element Pa3 in which the potential is changed from the potential VLa to the potential V0. In the following, the waveform elements Pa1, Pa2, and Pa3 may be collectively referred to as a waveform element Pa.

The waveform element Pa1 is an expansion element for displacing the piezoelectric body Zb in the Z2 direction. In the expansion element, the potential of the drive signal COM is changed to drive the piezoelectric element PZ for expanding the volume of the cavity CV. Therefore, in the waveform element Pa1, the potential of the drive signal COM changes to expand a volume of the cavity CV. When the volume of the cavity CV is expanded, a surface of an ink in the nozzle N is pulled in the Z2 direction, which is a direction opposite to an ejection direction, as in the Phase-2 state illustrated in FIG. 4. In the following, the pulling of the surface of the ink in the nozzle N in the direction opposite to the ejection direction may be referred to as a pull.

In addition, the waveform element Pa2 is a maintenance element for maintaining a position of the piezoelectric body Zb in the Z-axis direction. For example, in the waveform element Pa2, the potential of the drive signal COM is maintained to drive the piezoelectric element PZ for maintaining the volume of the cavity CV expanded by the waveform element Pa1.

In addition, the waveform element Pa3 is a contraction element for displacing the piezoelectric body Zb in the Z1 direction. In the contraction element, the potential of the drive signal COM is changed to drive the piezoelectric element PZ for contracting the volume of the cavity CV. Therefore, in the waveform element Pa3, the potential of the drive signal COM is changed to contract the volume of the cavity CV. When the volume of the cavity CV is contracted, the surface of the ink in the nozzle N is pushed out in the Z1 direction, which is the ejection direction. In the present embodiment, the surface of the ink in the nozzle N is pushed out in the Z1 direction by the waveform element Pa3 to such an extent that the ink is not ejected from the nozzle N. In the following, the act of pushing the surface of the ink in the nozzle N in the ejection direction may be referred to as a push.

In this manner, the pulse PA is a so-called pull-push waveform. Meanwhile, the waveform of the drive signal COM with which the ink is not ejected from the nozzle N is not limited to the pull-push waveform.

For example, when the ejecting section D[m] is designated as the determination target ejecting section D by the individual designation signal Sd[m], the coupling state designation circuit 310 sets the coupling state designation signal Qa[m] to a high level and the coupling state designation signal Qs[m] to a low level in the control period TSS1, respectively. Then, the coupling state designation circuit 310 sets the coupling state designation signal Qa[m] to a low level and the coupling state designation signal Qs[m] to a high level in the control period TSS2, respectively.

When the control period TSS1 and the control period TSS2 are switched, it is preferable that the state of each of the switches SWa[m] and SWs[m] is switched between on and off via a state in which both the switches SWa[m] and SWs[m] are turned on. That is, it is preferable that a time at which the coupling state designation signal Qs[m]transitions from a low level to a high level is a time earlier than a time at which the coupling state designation signal Qa[m]transitions from a high level to a low level. In addition, it is preferable that a time at which the coupling state designation signal Qs[m]transitions from a high level to a low level is a time after a time at which the coupling state designation signal Qa[m]transitions from a low level to a high level. In this case, since the state in which both the switch SWa[m] and the switch SWs[m] are turned off does not occur when the control period TSS1 and the control period TSS2 are switched, a change in the potential of the node N2 illustrated in FIG. 6 due to a switching noise or the like can be suppressed.

In addition, it is preferable that a time at which the detection period signal Acut transitions from a high level to a low level is a time after the time at which the coupling state designation signal Qa[m]transitions from a high level to a low level and the time at which the coupling state designation signal Qs[m]transitions from a low level to a high level. In addition, it is preferable that a time at which the detection period signal Acut transitions from a low level to a high level is a time earlier than the time at which the coupling state designation signal Qa[m]transitions from a low level to a high level and the time at which the coupling state designation signal Qs[m]transitions from a high level to a low level. Therefore, in the present embodiment, as described above, the coupling state designation circuit 310 sets the detection period signal Acut to a low level with the end of the pulse PlsT1 as a trigger, and sets the detection period signal Acut to a high level when the start of the pulse PlsT2 as a trigger. The coupling state designation circuit 310 may set the detection period signal Acut to a low level with a start of the pulse PlsT1 as a trigger and set the detection period signal Acut to a high level with a start of the next pulse PlsL as a trigger, as long as the transition time described above is satisfied.

By setting a time for transitioning the level of the detection period signal Acut to satisfy the transition time described above, generation of a noise or the like in the first input signal Vs1 and the second input signal Vs2 can be suppressed. When the noise or the like generated in the first input signal Vs1 and the second input signal Vs2 is suppressed within an allowable range, the time of transitioning the level of the detection period signal Acut may not satisfy the transition time described above.

The piezoelectric element PZ[m] included in the determination target ejecting section D[m] is driven by the pulse PA of the drive signal COM in the control period TSS1. Specifically, the piezoelectric element PZ[m] included in the determination target ejecting section D[m] is displaced by the pulse PA of the drive signal COM in the control period TSS1. As a result, a vibration occurs in the determination target ejecting section D[m]. The vibration occurring in the control period TSS1 remains in the control period TSS2. In the control period TSS2, a potential of the upper electrode Zu[m] of the piezoelectric element PZ[m] included in the determination target ejecting section D[m] is changed according to residual vibration generated in the determination target ejecting section D[m]. That is, in the control period TSS2, the potential of the upper electrode Zu of the piezoelectric element PZ included in the determination target ejecting section D is a potential according to an electromotive force of the piezoelectric element PZ caused by the residual vibration occurring in the determination target ejecting section D. The potential of the upper electrode Zu is detected as the potential signal Vzu in the control period TSS2. Therefore, the change in the potential of the upper electrode Zu is detected as the detection signal Vout in the control period TSS2. As a result, the detection signal Vout as a residual vibration signal generated by residual vibration in the ejecting section D is input to the detection circuit 33.

The detection signal Vout input to the detection circuit 33 is supplied to the first inspection signal generation circuit 340 as the first input signal Vs1 in the detection period Tdet1 of the control period TSS2. Therefore, in the inspection period Tche following the detection period Tdet1, the first inspection signal Vd1 is generated by the first inspection signal generation circuit 340 as a pseudo residual vibration signal obtained by emulating the residual vibration of the ejecting section D[m].

Next, an operation of the ink jet printer 1 when executing a printing process will be briefly described. In the printing process, the unit period TU may not be divided into the control period TSS1 and the control period TSS2. In this case, in the unit period TU, the period defining signal Tsig may be maintained at a low level, and the detection period signal Acut may be maintained at a high level.

The coupling state designation signal Qs[m] is maintained at a low level in the unit period TU, for example, regardless of whether or not the ejecting section D[m] is designated as the ejecting section D for forming dots. Further, the coupling state designation signal Qa[m] is set to a high level or a low level depending on whether or not the ejecting section D[m] is designated as the ejecting section D for forming dots.

For example, when the ejecting section D[m] is designated as the ejecting section D for forming dots by the individual designation signal Sd[m], the coupling state designation circuit 310 sets the coupling state designation signal Qa[m] to a high level in the unit period TU. The coupling state designation signal Qa corresponding to the ejecting section D that does not form dots is set to a low level in the unit period TU.

By setting the coupling state designation signal Qa[m] to a high level, the drive signal COM including a pulse for ejecting inks from the nozzle N is supplied from the drive signal generation unit 4 to the ejecting section D for forming dots. For example, the pulse with which the ink is ejected from the nozzle N is supplied to the wiring La in the unit period TU. The pulse with which the ink is ejected from the nozzle N may be a pull-push waveform, as in the pulse PA. In this case, the pulse with which the ink is ejected from the nozzle N is defined such that a potential difference between a start and an end of a contraction element, which is a waveform element for ejecting the ink, is larger than a potential difference between a start and an end of the waveform element Pa3 of the pulse PA. The pulse for ejecting the ink from the nozzle N is not limited to the pull-push waveform. For example, the pulse for ejecting the ink from the nozzle N may be a pull-push-pull waveform.

When the individual drive signal Vin[m] having the pulse is supplied to the ejecting section D[m], each waveform element of the pulse with which the ink is ejected from the nozzle N is determined such that a predetermined amount of ink is ejected from the ejecting section D[m]. In the present embodiment, a case is assumed in which a volume of the cavity CV provided in the ejecting section D[m] is reduced when a potential of the individual drive signal Vin[m] is a high potential as compared with a case where the potential is a low potential. Therefore, when the ejecting section D[m] is driven by the individual drive signal Vin[m] having a pulse for ejecting the ink, the ink in the ejecting section D[m] is ejected from the nozzle N by a waveform element in which the potential of the individual drive signal Vin[m] is changed from a low potential to a high potential.

For example, each waveform element of the pulse for ejecting the ink from the nozzle N is determined based on ejection characteristics of the ink by the ejecting section D. The ejection characteristic of the ink is, for example, the amount of ink ejected as ink droplets, an ejection rate of the ejected ink droplets, or the like. The ejection rate of the ink droplet is changed, for example, depending on a viscosity of the ink. For example, the ejection rate of ink droplets thickened more than predetermined viscosity is lower than the ejection rate of ink droplets having viscosity equal to or lower than the predetermined viscosity. Details will be described below with reference to FIG. 19, but in the present embodiment, a thickened state of the ink in the ejecting section D can be determined based on a pseudo residual vibration signal.

In the present embodiment, it is assumed that the pulse PA is a pulse with which the ink is not ejected from the nozzle N, and thus the ejection state determination process can be executed even when the head unit 3 is not located on the discharge ink receiving section 80. For example, when printing is performed for each pass while moving the head unit 3 along the X-axis direction, the ejection state determination process may be executed between the passes. The ejection state determination process may be executed between a print job based on one print data IMG and a print job based on the other print data IMG. Alternatively, the ejection state determination process may be executed when executing a maintenance process.

The operation of the ink jet printer 1 is not limited to the example illustrated in FIG. 18. For example, the pulse PA may be a pulse for ejecting the ink from the nozzle N. In this case, the drive signal COM including the pulse PA may be used in both the printing process and the ejection state determination process. Meanwhile, when the pulse PA used for the ejection state determination process is a pulse for ejecting the ink from the nozzle N, it is preferable that the ejection state determination process is executed in a state in which the head unit 3 is located on the discharge ink receiving section 80, for example.

In addition, for example, when executing the ejection state determination process, the control unit 2 may output the period defining signal Tsig having only the pulse PlsT1 among the pulse PlsT1 and the pulse PlsT2. In this case, for satisfying the transition time described above, for example, the coupling state designation circuit 310 may set the detection period signal Acut to a low level with the start or the end of the pulse PlsT1 as a trigger, and may set the detection period signal Acut to a high level with the start of the next pulse PlsL as a trigger.

In addition, for example, in FIG. 18, a case where one drive signal COM is illustrated, but the present disclosure is not limited to such an aspect. For example, a plurality of drive signals COM including the drive signal COM with which an ink is not ejected from the nozzle N and the drive signal COM with which the ink is ejected from the nozzle N may be used. In this case, in the printing process, the pulse PA with which the ink is not ejected may be used to prevent the thickening of the ink. The drive signal COM with which the ink is ejected from the nozzle N may have a plurality of pulses with which the inks are ejected from the nozzle N to form dots having different sizes.

Next, the first inspection signal Vd1 generated by the first inspection signal generation circuit 340 will be described with reference to FIG. 19.

FIG. 19 is an explanatory diagram describing an example of the first inspection signal Vd1 generated by the first inspection signal generation circuit 340. In FIG. 19, for the sake of explanation, any one of numbers of 1, 2, and 3 is added to an end of each code of the plurality of unit periods TU. Further, in FIG. 19, a case is assumed in which the ejecting section D[a] is designated as the determination target ejecting section D in the unit period TU1 and the ejecting section D[b] is designated as the determination target ejecting section D in the unit period TU2. The value a is a natural number satisfying “1≤a≤M”, and the value b is a natural number satisfying “1≤b≤M” and different from the value a. The time ts is a time required for a potential of the detection signal Vout input to the first inspection signal generation circuit 340 to be changed from the maximum value to the minimum value or a time required for the potential of the detection signal Vout to be changed from the minimum value to the maximum value in the detection period Tdet1.

The detection signal Vout is input to the first inspection signal generation circuit 340 as the first input signal Vs1 in the detection period Tdet1 which is in a period in which the detection period signal Acut is a low level. For example, in the detection period Tdet1[a] of the unit period TU1, the detection signal Vout indicating residual vibration of the ejecting section D[a] driven by the individual drive signal Vin[a] is input to the first inspection signal generation circuit 340 as the first input signal Vs1. Then, the first input signal Vs1 is switched from the detection signal Vout to the first reference potential Vref1 by an end of the detection period Tdet1[a]. Therefore, in the inspection period Tche[a], a potential of the first input signal Vs1 converges to the first reference potential Vref1.

As illustrated in FIG. 19, the detection signal Vout input to the first inspection signal generation circuit 340 as the first input signal Vs1 is the detection signal Vout of less than one cycle. Therefore, in the first inspection signal generation circuit 340, a length of the detection period Tdet1 can be reduced as compared with the second inspection signal generation circuit 350 to which the detection signal Vout having one cycle or more is input as the second input signal Vs2. Therefore, in the present embodiment, the unit period TU when the inspection signal VD is generated by the first inspection signal generation circuit 340 can be made shorter than the unit period TU when the inspection signal VD is generated by the second inspection signal generation circuit 350.

In the inspection period Tche[a] following the detection period Tdet1[a], the wiring Ls2 that couples the switching circuit 31 and the detection circuit 33 is electrically separated from the first inspection signal generation circuit 340. Therefore, the first inspection signal generation circuit 340 can generate the first inspection signal Vd1 that emulates an attenuation wave of the detection signal Vout indicating the residual vibration of the ejecting section D[a], even when the individual drive signal Vin[b] is supplied to the ejecting section D[b] in the inspection period Tche[a].

For example, the first filter circuit 344 is a multiplex feedback type band pass filter having a characteristic in which a group delay is changed largely in the vicinity of the center frequency f₀ as described in FIG. 14. Therefore, the attenuation vibration waveform corresponding to the detection signal Vout is generated at the center frequency f₀. After the input of the detection signal Vout to the first filter circuit 344 is ended, that is, after the end of the detection period Tdet1, the first filter output signal Obpf1 having the attenuation vibration waveform generated at the center frequency f₀ is output from the first filter circuit 344. Therefore, for example, in the inspection period Tche[a], the first inspection signal Vd1 having an attenuation vibration waveform corresponding to the detection signal Vout indicating the residual vibration of the ejecting section D[a] is output from the first inspection signal generation circuit 340 to the inspection unit 6. In addition, for example, in the inspection period Tche[b], the first inspection signal Vd1 having the attenuation vibration waveform corresponding to the detection signal Vout indicating the residual vibration of the ejecting section D[b] is output from the first inspection signal generation circuit 340 to the inspection unit 6.

The inspection unit 6 determines the state of the ejecting section D[a] based on the first inspection signal Vd1 output from the first inspection signal generation circuit 340 as the inspection signal VD[a] in the inspection period Tche[a]. Further, the inspection unit 6 determines the state of the ejecting section D[b] based on the first inspection signal Vd1 output from the first inspection signal generation circuit 340 as the inspection signal VD[b] in the inspection period Tche[b]. The inspection unit 6 may determine the state of the ejecting section D based on the first inspection signal Vd1 output from the first inspection signal generation circuit 340 as the inspection signal VD in the period including the detection period Tdet1 and the inspection period Tche. That is, the inspection unit 6 may determine the state of the ejecting section D based on the first inspection signal Vd1 output from the first inspection signal generation circuit 340 in the inspection period Tche and the first inspection signal Vd1 output from the first inspection signal generation circuit 340 in the detection period Tdet1.

In the example illustrated in FIG. 19, a waveform of the first input signal Vs1 of the solid line indicates the waveform of the first input signal Vs1 when the state of the ejecting section D is normal, and the waveform of the first input signal Vs1 of the broken line indicates the waveform of the first input signal Vs1 when the ink in the ejecting section D is in a thickened state. In the same manner, the waveform of the solid line of the inspection signal VD illustrates a waveform of the inspection signal VD when the state of the ejecting section D is normal, and the waveform of the broken line of the inspection signal VD illustrates the waveform of the inspection signal VD when the ink in the ejecting section D is in a thickened state. As illustrated in FIG. 19, an amplitude of the inspection signal VD is different between a case where the state of the ejecting section D is normal and a case where the ink in the ejecting section D is in a thickened state.

For example, the amplitude of the inspection signal VD when the ink in the ejecting section D is in a thickened state is smaller than the amplitude of the inspection signal VD when the state of the ejecting section D is normal. A difference dA11 in FIG. 19 indicates a difference between an amplitude of a first peak of the inspection signal VD in the inspection period Tche when the state of the ejecting section D is normal and the amplitude of the first peak of the inspection signal VD in the inspection period Tche when the ink in the ejecting section D is in a thickened state. In addition, a difference dA21 in FIG. 19 indicates a difference between an amplitude of a second peak of the inspection signal VD in the inspection period Tche when the state of the ejecting section D is normal and the amplitude of the second peak of the inspection signal VD in the inspection period Tche when the ink in the ejecting section D is in a thickened state.

It is checked with a simulation by the inventor that a change rate of the amplitude of the inspection signal VD between the case where the state of the ejecting section D is normal and the case where the ink in the ejecting section D is in a thickened state is substantially the same as the case where the second inspection signal Vd2 is used as the inspection signal VD. For example, in a simulation when the first inspection signal Vd1 is used as the inspection signal VD, a change rate calculated based on the difference dA11, that is, the change rate of the amplitude of the first peak of the inspection signal VD in the inspection period Tche is 43%. In addition, a simulation result of the change rate calculated based on the difference dA21, that is, the change rate of the amplitude of the second peak of the inspection signal VD in the inspection period Tche is 54%. On the other hand, in a simulation when the second inspection signal Vd2 is used as the inspection signal VD, the change rate calculated based on a difference dA12 illustrated in FIG. 20 is 36%, and the change rate calculated based on a difference dA22 illustrated in FIG. 20 is 50%. The first peak of the inspection signal VD in the inspection period Tche corresponds to the second peak of the inspection signal VD in a period including the detection period Tdet1 and the inspection period Tche. Therefore, the differences dA12 and dA22 illustrated in FIG. 20 respectively correspond to the differences dA11 and dA21.

In this manner, even when the first inspection signal Vd1 is used as the inspection signal VD, the state of the ejecting section D can be determined based on the change rate of the amplitude of the inspection signal VD with respect to a reference amplitude value. The reference amplitude value is determined in advance based on, for example, the amplitude of the inspection signal VD when the state of the ejecting section D is normal.

A method of specifying the amplitude of the inspection signal VD is not particularly limited, and a known method can be adopted. For example, the inspection unit 6 may compare a plurality of different threshold values and the potential of the inspection signal VD with each other, generate a plurality of pulses indicating the comparison results of a plurality of threshold values and the potential of the inspection signal VD, respectively, and specify an amplitude of the inspection signal VD based on widths of the generated plurality of pulses. The pulse indicating the comparison result between the threshold value and the potential of the inspection signal VD is, for example, a pulse that becomes a high level during a period in which the potential of the inspection signal VD is equal to or higher than the threshold value. When the inspection unit 6 has, for example, a comparator that compares the plurality of threshold values with the potential of the inspection signal VD, the comparator may be provided in the head unit 3. In this case, the inspection unit 6 has the comparator provided in the head unit 3 and an element provided outside the head unit 3.

In this manner, in the present embodiment, a part or all of the inspection period Tche[a] for generating the first inspection signal Vd1 in response to the residual vibration of the ejecting section D[a] can be overlapped with the control period TSS1 for driving the ejecting section D[b] different from the ejecting section D[a]. Therefore, in the present embodiment, by using the first inspection signal Vd1 as the inspection signal VD for determining the state of the ejecting section D, a time required for determining the state of the plurality of ejecting sections D including the ejecting section D[a] and the ejecting section D[b] can be reduced.

Next, the second inspection signal Vd2 generated by the second inspection signal generation circuit 350 will be described with reference to FIG. 20.

FIG. 20 is an explanatory diagram describing an example of the second inspection signal Vd2 generated by the second inspection signal generation circuit 350. In FIG. 20, for the sake of explanation, any one of numbers of 1 and 2 is added to an end of each code of the plurality of unit periods TU. Further, in FIG. 20, it is assumed that the ejecting section D[a] is designated as the determination target ejecting section D in the unit period TU1. The value a is a natural number satisfying “1≤a≤M”. In addition, in FIG. 20, the detection period Tdet1 when the first inspection signal Vd1 is used as the inspection signal VD is indicated by a broken line arrow.

The detection signal Vout is input to the second inspection signal generation circuit 350 as the second input signal Vs2 in the detection period Tdet2 which is in a period in which the detection period signal Acut is a low level. For example, in the detection period Tdet2[a] of the unit period TU1, the detection signal Vout indicating residual vibration of the ejecting section D[a] driven by the individual drive signal Vin[a] is input to the second inspection signal generation circuit 350 as the second input signal Vs2. Then, the second input signal Vs2 is switched from the detection signal Vout to the second reference potential Vref2 by an end of the detection period Tdet2[a]. Therefore, in the control period TSS1 of the unit period TU2, a potential of the second input signal Vs2 converges to the second reference potential Vref2.

As illustrated in FIG. 20, the detection signal Vout input to the second inspection signal generation circuit 350 as the second input signal Vs2 is the detection signal Vout having one cycle or more. Therefore, in the second inspection signal generation circuit 350, a length of the detection period Tdet2 is longer than a length of the detection period Tdet1 when the first inspection signal Vd1 is used as the inspection signal VD.

Further, the second filter circuit 354 is a band pass filter that passes a signal of a predetermined frequency component, as described in FIG. 13. Therefore, the second filter output signal Obpf2, from which the frequency components other than the predetermined frequency components are removed from the second filter input signal INbpf2 obtained by adjusting an amplitude of the detection signal Vout, is output from the second filter circuit 354. Therefore, for example, in the detection period Tdet2[a], the second inspection signal Vd2 from which the frequency components other than the predetermined frequency component are removed from a signal corresponding to the detection signal Vout indicating the residual vibration of the ejecting section D[a] is output from the second inspection signal generation circuit 350 to the inspection unit 6.

In the detection period Tdet2[a], the wiring Ls2 that couples the switching circuit 31 and the detection circuit 33 is electrically coupled to the second inspection signal generation circuit 350. Therefore, when a state of the ejecting section D[a] is determined based on the second inspection signal Vd2, it is preferable not to drive the other ejecting sections D until the detection period Tdet2[a] is ended, that is, until the generation of the second inspection signal Vd2 is completed.

As described above, the second inspection signal generation circuit 350 generates the second inspection signal Vd2 based on the detection signal Vout having one cycle or more, in the detection period Tdet2[a]. Therefore, the inspection unit 6 determines the state of the ejecting section D[a] based on the second inspection signal Vd2 output from the second inspection signal generation circuit 350 as the inspection signal VD[a] in the detection period Tdet2[a].

In the example illustrated in FIG. 20, the waveform of the solid line of the second input signal Vs2 illustrates the waveform of the second input signal Vs2 when the state of the ejecting section D is normal, and the waveform of the broken line of the second input signal Vs2 illustrates the waveform of the second input signal Vs2 when an ink in the ejecting section D is in a thickened state. In the same manner, the waveform of the solid line of the inspection signal VD illustrates a waveform of the inspection signal VD when the state of the ejecting section D is normal, and the waveform of the broken line of the inspection signal VD illustrates the waveform of the inspection signal VD when the ink in the ejecting section D is in a thickened state. Even when the inspection signal VD is generated by the second inspection signal generation circuit 350, as illustrated in FIG. 20, the amplitude of the inspection signal VD is different between a case where the state of the ejecting section D is normal and a case where the ink in the ejecting section D is in a thickened state.

For example, the amplitude of the inspection signal VD when the ink in the ejecting section D is in a thickened state is smaller than the amplitude of the inspection signal VD when the state of the ejecting section D is normal. The difference dA12 in FIG. 20 indicates a difference between an amplitude of a second peak of the inspection signal VD in the detection period Tdet2 when the state of the ejecting section D is normal and the amplitude of the second peak of the inspection signal VD in the detection period Tdet2 when the ink in the ejecting section D is in a thickened state. In addition, the difference dA22 in FIG. 20 indicates a difference between an amplitude of a third peak of the inspection signal VD in the detection period Tdet2 when the state of the ejecting section D is normal and the amplitude of the third peak of the inspection signal VD in the detection period Tdet2 when the ink in the ejecting section D is in a thickened state.

The second peak of the inspection signal VD in the detection period Tdet2 illustrated in FIG. 20 corresponds to the first peak of the inspection signal VD in the inspection period Tche illustrated in FIG. 19. In addition, the third peak of the inspection signal VD in the detection period Tdet2 illustrated in FIG. 20 corresponds to the second peak of the inspection signal VD in the inspection period Tche illustrated in FIG. 19.

In this manner, even when the second inspection signal Vd2 is used as the inspection signal VD, the state of the ejecting section D can be determined based on a change rate of the amplitude of the inspection signal VD with respect to a reference amplitude value, as in the case where the first inspection signal Vd1 is used as the inspection signal VD.

The second inspection signal Vd2 is generated based on the detection signal Vout having one cycle or more as described above. Therefore, in the present embodiment, the state of the ejecting section D may be determined based on a part or all of the amplitude, the cycle, and the phase of the second inspection signal Vd2. In the present embodiment, a plurality of state abnormalities including a thickened state of the ink in the ejecting section D can be determined based on the second inspection signal Vd2 generated based on the detection signal Vout of one cycle or more. A state abnormality other than the thickened state of the ink in the ejecting section D includes, for example, a state in which an ejection abnormality occurs due to mixing of air bubbles into the cavity CV of the ejecting section D, and a state in which an ejection abnormality occurs due to adhesion of foreign matter in the vicinity of the nozzle N of the ejecting section D. For example, the determination on the state of the ejecting section D in the second mode in which the state of the ejecting section D is determined based on the second inspection signal Vd2 is effective when it is desired to accurately know a cause of the ejection abnormality.

Since with the determination of the state of the ejecting section D in the first mode in which the state of the ejecting section D is determined based on the first inspection signal Vd1, the unit period TU can be reduced than in the second mode, the first mode is effective when the state of the ejecting section D is to be determined in a short time. For example, immediately after the ink jet printer 1 is started, an ink in the cavity CV is in a stagnant state, and the ink is likely to be thickened. Therefore, the determination of the state of the ejecting section D in the first mode may be performed with a higher priority than the determination of the state of the ejecting section D in the second mode after the ink jet printer 1 is started. In this case, a time required for determining the state of the ejecting section D after the ink jet printer 1 is started can be prevented from being increased. In this manner, in the present embodiment, the mode for determining the state of the ejecting section D can be switched according to the purpose of determining the state of the ejecting section D, the scene where the determination is performed, and the like. For example, the first mode may be a mode in which a thickened state of the ink in the ejecting section D is determined based on the first inspection signal Vd1. The second mode may be a mode in which a plurality of state abnormalities including a thickened state of the ink in the ejecting section D are determined based on the second inspection signal Vd2.

In the above description, in the present embodiment, the ink jet printer 1 includes the head unit 3, the drive signal generation unit 4 that generates the drive signal COM, and the inspection unit 6 that determines the state of the ejecting section D based on a pseudo residual vibration signal. The head unit 3 includes the ejecting section D including the nozzle N, the piezoelectric element PZ driven by the drive signal COM, and the cavity CV for ejecting inks from the nozzle N in response to the drive of the piezoelectric element PZ, and the first inspection signal generation circuit 340 to which a residual vibration signal generated by residual vibration in the ejecting section D after the piezoelectric element PZ is driven is input and which generates a pseudo residual vibration signal according to the residual vibration signal, as a signal for determining the state of the ejecting section D. The first inspection signal generation circuit 340 includes the first filter circuit 344 that generates the pseudo residual vibration signal, and the first filter circuit 344 includes the variable resistor element Rv43 having an adjustable resistance value. In the present embodiment, for example, the detection signal Vout is input to the first inspection signal generation circuit 340 as the residual vibration signal, and the first inspection signal generation circuit 340 generates the first inspection signal Vd1 as the pseudo residual vibration signal.

In this manner, in the present embodiment, the pseudo residual vibration signal corresponding to the residual vibration signal is generated by the first filter circuit 344 as a signal for determining the state of the ejecting section D. For example, in the present embodiment, by generating the pseudo residual vibration signal based on the residual vibration signal of less than one cycle, a time assigned for the detection of the residual vibration signal can be reduced as compared with a case where the state of the ejecting section D is determined by using the residual vibration signal of one cycle or more. Therefore, in the present embodiment, when the state of the ejecting section D is determined, a length of the unit period TU, which is a cycle for driving the ejecting section D, can be prevented from being increased. That is, the length of the unit period TU when the state of the ejecting section D is determined can be reduced. In the present embodiment, the characteristic of the pseudo residual vibration signal generated by the first filter circuit 344 can be adjusted by adjusting a resistance value of the variable resistor element Rv43 included in the first filter circuit 344.

In the present embodiment, the first filter circuit 344 includes the variable capacitors Cv41 and Cv42 having an adjustable capacitance value. Therefore, in the present embodiment, the characteristics of the pseudo residual vibration signal generated by the first filter circuit 344 can be adjusted by adjusting the capacitance values of the variable capacitors Cv41 and Cv42 included in the first filter circuit 344.

In addition, in the present embodiment, the first filter circuit 344 further includes the operational amplifier OP42 including an inversion input terminal and a non-inversion input terminal to which the first reference potential Vref1 is supplied, the resistor element R41 of which one end is supplied with the residual vibration signal and the other end is electrically coupled to the node N41, the resistor element R42 of which one end is coupled to the inversion input terminal of the operational amplifier OP42 and the other end is electrically coupled to an output terminal of the operational amplifier OP42, the variable capacitor Cv41 of which one end is electrically coupled to the node N41 and the other end is coupled to the inversion input terminal of the operational amplifier OP42, and the variable capacitor Cv42 of which one end is electrically coupled to the node N41 and the other end is electrically coupled to the output terminal of the operational amplifier OP42. One end of the variable resistor element Rv43 is electrically coupled to the node N41, and the first reference potential Vref1 is supplied to the other end. The variable capacitors Cv41 and Cv42 are capacitors having an adjustable capacitance value. One of the variable capacitors Cv41 and Cv42 may be replaced with a capacitor having a non-adjustable capacitance value.

In this manner, in the present embodiment, the first filter circuit 344 includes the first feedback path FB1 through which a signal output from the operational amplifier OP42 is fed back to the inversion input terminal via the resistor element R42, and the second feedback path FB2 through which the signal output from the operational amplifier OP42 is fed back to the inversion input terminal via the variable capacitor Cv42 and the variable capacitor Cv41. That is, in the present embodiment, the first filter circuit 344 is a multiplex feedback type band pass filter. Therefore, in the present embodiment, the pseudo residual vibration signal having one cycle or more can be generated based on the residual vibration signal having less than one cycle. In the present embodiment, the first filter circuit 344 that generates the pseudo residual vibration signal can be configured with a simple circuit including the operational amplifier OP42, the resistor elements R41 and R42, the variable resistor element Rv43, and the variable capacitors Cv41 and Cv42.

In the present embodiment, the resistance value of the resistor element R41 may be equal to the resistance value of the resistor element R42. In this case, a design of the first filter circuit 344, the adjustment of the amplitude of the pseudo residual vibration signal, and the like can be prevented from being complicated.

In the present embodiment, the capacitance value after adjustment of the variable capacitor Cv41 may be equal to the capacitance value after adjustment of the variable capacitor Cv42. In this case, the design of the first filter circuit 344, the adjustment of the cycle of the pseudo residual vibration signal, and the like can be prevented from being complicated.

In the present embodiment, the cycle of the pseudo residual vibration signal is changed by adjusting the capacitance values of the variable capacitors Cv41 and Cv42. Therefore, in the present embodiment, the cycle of the pseudo residual vibration signal generated by the first filter circuit 344 can be adjusted by adjusting the capacitance values of the variable capacitors Cv41 and Cv42.

Further, in the present embodiment, the amplitude of the pseudo residual vibration signal changes by adjusting the resistance value of the variable resistor element Rv43. Therefore, in the present embodiment, the amplitude of the pseudo residual vibration signal generated by the first filter circuit 344 can be adjusted by adjusting the resistance value of the variable resistor element Rv43.

In the present embodiment, the cycle of the residual vibration signal input to the first filter circuit 344 is ¼ cycle or more and less than one cycle, and the cycle of the pseudo residual vibration signal output from the first filter circuit 344 is equal to or more than one cycle. In the present embodiment, for example, the first filter input signal INbpf1 is input to the first filter circuit 344 as the residual vibration signal input to the first filter circuit 344, and the first filter output signal Obpf1 is output from the first filter circuit 344 as the pseudo residual vibration signal output from the first filter circuit 344. In this manner, in the present embodiment, the pseudo residual vibration signal having one cycle or more is generated based on the residual vibration signal having ¼ cycle or more and less than one cycle. Therefore, in the present embodiment, the state of the ejecting section D can be accurately determined while the length of the unit period TU is reduced.

In the present embodiment, the first inspection signal generation circuit 340 includes the low-pass filter circuit 343. The residual vibration signal is input to the first filter circuit 344 via the low-pass filter circuit 343. Therefore, in the present embodiment, the residual vibration signal from which a noise or the like is removed can be input to the first filter circuit 344. As a result, in the present embodiment, occurrence of a distortion in the pseudo residual vibration signal can be suppressed.

In the present embodiment, the inspection unit 6 determines a thickened state of the ink in the ejecting section D. That is, the pseudo residual vibration signal is used to determine the thickened state of the ink in the ejecting section D. Therefore, in the present embodiment, a time required for determining the thickened state of the ink in the ejecting section D can be prevented from being increased. For example, in the present embodiment, the time required for determining the thickened state of the ink in the plurality of ejecting sections D can be reduced.

### 2. MODIFICATION EXAMPLE

Each embodiment above can be variously modified. A specific aspect of the modification will be described below. Two or more aspects selected in any manner from the following examples can be combined with each other as appropriate within a range not inconsistent with each other. In addition, in the modification examples described below, elements having the same effects and functions as those of the embodiment will be given the reference numerals used in the description above, and each detailed description thereof will be omitted as appropriate.

### First Modification Example

In the embodiment described above, some elements of the first filter circuit 344 may be shared with the second filter circuit 354.

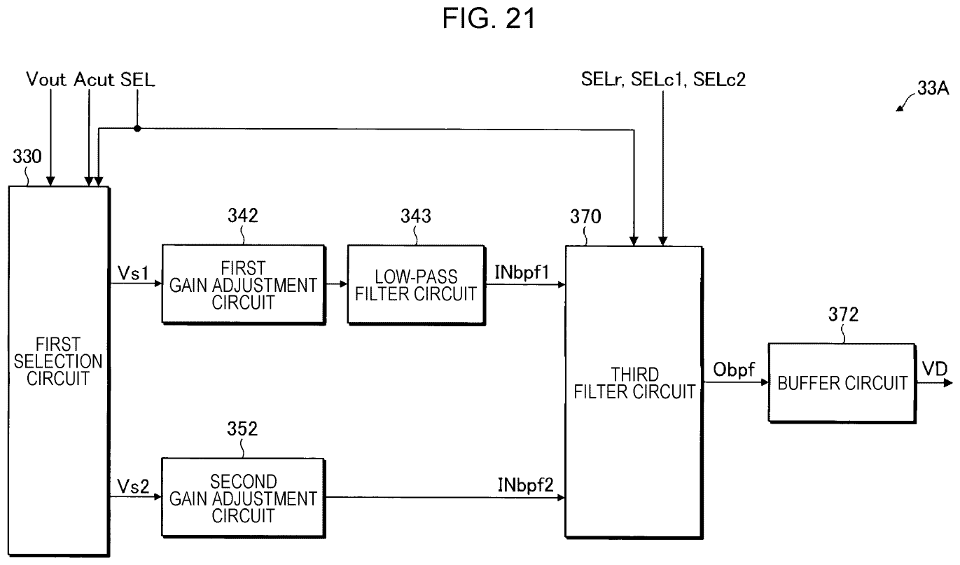

FIG. 21 is a block diagram illustrating an example of a configuration of a detection circuit 33A according to a first modification example. The same elements as those described in FIGS. 1 to 20 are designated by the same reference numerals, and detailed explanations thereof will be omitted.

The ink jet printer 1 according to the present modification example has the same manner as the ink jet printer 1 illustrated in FIG. 1, except that the detection circuit 33A illustrated in FIG. 21 is provided instead of the detection circuit 33 illustrated in FIG. 1. The detection circuit 33A includes, for example, the first selection circuit 330, the first gain adjustment circuit 342, the low-pass filter circuit 343, the second gain adjustment circuit 352, a third filter circuit 370, and a buffer circuit 372.

The first selection circuit 330, the first gain adjustment circuit 342, the low-pass filter circuit 343, and the second gain adjustment circuit 352 are the same as the first selection circuit 330, the first gain adjustment circuit 342, the low-pass filter circuit 343, and the second gain adjustment circuit 352 illustrated in FIG. 7, respectively. Meanwhile, the first filter input signal INbpf1, which is an output signal of the low-pass filter circuit 343, and the second filter input signal INbpf2, which is an output signal of the second gain adjustment circuit 352, are input to the third filter circuit 370. Further, the selection signals SELr, SELc1, and SELc2 are input to the third filter circuit 370.

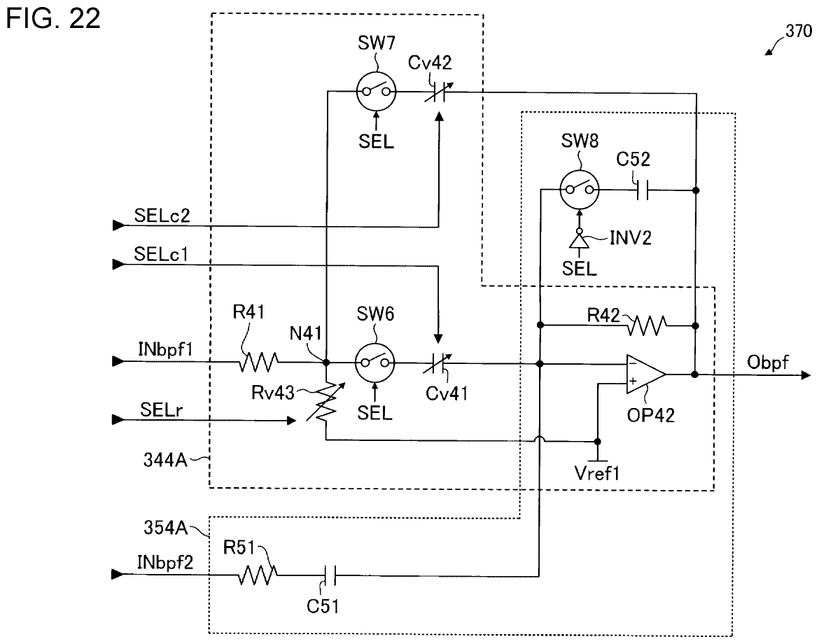

The third filter circuit 370 is a filter circuit in which, for example, the function of the first filter circuit 344 illustrated in FIG. 9 is switched to the function of the second filter circuit 354 illustrated in FIG. 13 based on the selection signal SEL. For example, the third filter circuit 370 functions as the first filter circuit 344 when the selection signal SEL is at a high level, and functions as the second filter circuit 354 when the selection signal SEL is at a low level. Although details will be described below with reference to FIG. 22, in the third filter circuit 370, some elements of a plurality of elements of the first filter circuit 344 and a plurality of elements of the second filter circuit 354 are shared between the first filter circuit 344 and the second filter circuit 354.

An output signal of the third filter circuit 370 is supplied to the buffer circuit 372 as a filter output signal Obpf.

The buffer circuit 372 is a buffer that converts an impedance, and outputs the inspection signal VD having a low impedance. For example, the buffer circuit 372 is configured with a voltage follower using the operational amplifier OP43, in the same manner as the first buffer circuit 346 illustrated in FIG. 9. Therefore, the filter output signal Obpf supplied to the buffer circuit 372 is output from the buffer circuit 372 as the inspection signal VD having a low impedance.

Next, an outline of the third filter circuit 370 will be described with reference to FIG. 22.

FIG. 22 is a circuit diagram illustrating an example of a configuration of the third filter circuit 370 according to the first modification example. The same elements as those described in FIGS. 1 to 21 are designated by the same reference numerals, and detailed explanations thereof will be omitted.

A first filter circuit 344A illustrated in FIG. 22 corresponds to the first filter circuit 344 illustrated in FIG. 9, and a second filter circuit 354A illustrated in FIG. 22 corresponds to the second filter circuit 354 illustrated in FIG. 13. As illustrated in FIG. 22, in the third filter circuit 370, the operational amplifier OP42 and the resistor element R42 are shared between the first filter circuit 344A and the second filter circuit 354A. When the third filter circuit 370 functions as the second filter circuit 354A, the operational amplifier OP42 and the resistor element R42 respectively correspond to the operational amplifier OP51 and the resistor element R52 illustrated in FIG. 13.

The third filter circuit 370 includes, for example, the resistor elements R41, R42, and R51, the variable resistor element Rv43, the variable capacitors Cv41 and Cv42, the capacitors C51 and C52, the operational amplifier OP42, switches SW6, SW7, and SW8, and an inverter INV2.

One end of the resistor element R41 is coupled to an output terminal of the operational amplifier OP41 of the low-pass filter circuit 343, and the other end of the resistor element R41 is coupled to the node N41. One end of the variable capacitor Cv41 is coupled to the node N41 via the switch SW6, and the other end of the variable capacitor Cv41 is coupled to an inversion input terminal of the operational amplifier OP42. One end of the resistor element R42 is coupled to the inversion input terminal of the operational amplifier OP42, and the other end of the resistor element R42 is coupled to an output terminal of the operational amplifier OP42. One end of the variable resistor element Rv43 is coupled to the node N41, and the other end of the variable resistor element Rv43 is coupled to a wiring to which the first reference potential Vref1 is supplied. One end of the variable capacitor Cv42 is coupled to the node N41 via the switch SW7, and the other end of the variable capacitor Cv42 is coupled to the output terminal of the operational amplifier OP42. In addition, a non-inversion input terminal of the operational amplifier OP42 is coupled to the wiring to which the first reference potential Vref1 is supplied.

In addition, one end of the resistor element R51 is coupled to an output terminal of the operational amplifier OP50 of the second gain adjustment circuit 352, the other end of the resistor element R51 is coupled to one end of the capacitor C51, and the other end of the capacitor C51 is coupled to the inversion input terminal of the operational amplifier OP42. One end of the capacitor C52 is coupled to the inversion input terminal of the operational amplifier OP42 via the switch SW8, and the other end of the capacitor C52 is coupled to the output terminal of the operational amplifier OP42.

The inverter INV2 outputs an inversion signal of the selection signal SEL supplied from the coupling state designation circuit 310 to the switch SW8.

The switch SW6 is turned on when the selection signal SEL is at a high level, electrically couples the variable capacitor Cv41 and the node N41, and is turned off when the selection signal SEL is at a low level, electrically decouples the variable capacitor Cv41 and the node N41. The switch SW7 is turned on when the selection signal SEL is at a high level, electrically couples the variable capacitor Cv42 and the node N41, and is turned off when the selection signal SEL is at a low level, electrically decouples the variable capacitor Cv42 and the node N41. The switch SW8 is turned on when the selection signal SEL is at a low level, electrically couples the capacitor C52 and the inversion input terminal of the operational amplifier OP42, and is turned off when the selection signal SEL is at a high level, electrically decouples the capacitor C52 and the inversion input terminal of the operational amplifier OP42.

For example, when the selection signal SEL is at a high level, the second filter input signal INbpf2 is maintained at a constant potential, and the first filter input signal INbpf1 is input to the inversion input terminal of the operational amplifier OP42 via the resistor element R41, the switch SW6, and the variable capacitor Cv41. An output signal of the operational amplifier OP42 is fed back to the inversion input terminal of the operational amplifier OP42 via the resistor element R42. In addition, the output signal of the operational amplifier OP42 is fed back to the inversion input terminal of the operational amplifier OP42 via the variable capacitor Cv42, the switch SW7, the switch SW6, and the variable capacitor Cv4l. In this manner, when the selection signal SEL is at a high level, the third filter circuit 370 functions as a multiplex feedback type band pass filter in the same manner as the first filter circuit 344 illustrated in FIG. 9.

In addition, for example, when the selection signal SEL is at a low level, the first filter input signal INbpf1 is maintained at a constant potential, and the second filter input signal INbpf2 is input to the inversion input terminal of the operational amplifier OP42 via the resistor element R51 and the capacitor C51. The output signal of the operational amplifier OP42 is fed back to the inversion input terminal of the operational amplifier OP42 via the resistor element R42. In addition, the output signal of the operational amplifier OP42 is fed back to the inversion input terminal of the operational amplifier OP42 via the capacitor C52 and the switch SW8. In this manner, when the selection signal SEL is at a low level, the third filter circuit 370 functions as a band pass filter in the same manner as the second filter circuit 354 illustrated in FIG. 13.

As described above, in the present modification example as well, the same effect as the effect of the embodiment described above can be obtained. In addition, in the present modification example, the operational amplifier OP42 and the resistor element R42 are shared between the first filter circuit 344A and the second filter circuit 354A. Therefore, in the present modification example, a circuit scale of the detection circuit 33A can be reduced as compared with the detection circuit 33.

### Second Modification Example

In the embodiment described above, the first buffer circuit 346 may be omitted from the first inspection signal generation circuit 340, the second buffer circuit 356 may be omitted from the second inspection signal generation circuit 350, and the buffer circuit 372 may be provided at a subsequent stage of the second selection circuit 360. Alternatively, the first gain adjustment circuit 342, the first buffer circuit 346, the second gain adjustment circuit 352, and the second buffer circuit 356 may be omitted, and a gain adjustment circuit in the same manner as the first gain adjustment circuit 342 and the buffer circuit 372 may be provided at the subsequent stage of the second selection circuit 360. In addition, in the modification example described above, the first gain adjustment circuit 342 and the second gain adjustment circuit 352 may be omitted, and a gain adjustment circuit in the same manner as the first gain adjustment circuit 342 may be provided between the third filter circuit 370 and the buffer circuit 372.

As described above, in the present modification example as well, the same effect as the effect of the embodiment and modification example described above can be obtained. Further, in the present modification example, the first buffer circuit 346 and the like are omitted, so that the circuit scale of the detection circuit 33 or 33A can be reduced.

### Third Modification Example

In the embodiment and the modification example described above, the second inspection signal generation circuit 350 may be omitted. For example, the second reference potential generation circuit 336, the second switching circuit 337, and the negative logic sum circuit NOR2 included in the first selection circuit 330, the second inspection signal generation circuit 350, and the second selection circuit 360 may be omitted from the detection circuit 33. Also in the present modification example, the same effects as those of the embodiment and the modification example described above can be obtained except for the effect obtained by switching the mode when determining the state of the ejecting section D.

### Fourth Modification Example

In the embodiment and the modification example described above, the first selection circuit 330 may be omitted. Also in the present modification example, the same effects as those of the embodiment and the modification example described above can be obtained, except for the effect obtained by the first selection circuit 330.

### Fifth Modification Example

In the embodiment and the modification example described above, the number of times of determining the state of the ejecting section D in the first mode in one printing operation may be greater than the number of times of determining the state of the ejecting section D in the second mode. In the present modification example as well, the same effect as the effect of the embodiment and modification examples described above can be obtained. In the first mode, since the time assigned to the detection of the residual vibration of the ejecting section D can be reduced, the efficiency of printing is not significantly affected even when the number of times of determining the state of the ejecting section D in the first mode is large.

### Sixth Modification Example

In the embodiment and the modification example described above, a case where the first inspection signal Vd1 indicating the pseudo residual vibration signal is generated based on the residual vibration having ¼ cycle or more and less than one cycle of the ejecting section D is described as an example, but the present disclosure is not limited to such an aspect. For example, the first inspection signal Vd1 may be generated based on the residual vibration of one cycle of the ejecting section D, and the second inspection signal Vd2 may be generated based on the residual vibration longer than one cycle of the ejecting section D. In the present modification example as well, the same effect as the effect of the embodiment and modification examples described above can be obtained.

### Seventh Modification Example

In the embodiment and modification example described above, a case is described as an example in which the piezoelectric element PZ is displaced in the Z1 direction by changing a potential of the individual drive signal Vin[m] from a low potential to a high potential, and the present disclosure is not limited to such an aspect. For example, the piezoelectric element PZ that is displaced in the Z1 direction by the potential of the individual drive signal Vin[m] changing from the high potential to the low potential may be used. In this case, for example, the potential of the drive signal COM is changed from the low potential to the high potential in a portion corresponding to an expansion element, and is changed from the high potential to the low potential in a portion corresponding to a contraction element. In the present modification example as well, the same effect as the effect of the embodiment and modification examples described above can be obtained.

### Eighth Modification Example

In the embodiment and the modification example described above, a case where each head unit 3 has one nozzle row NL is described as an example, but the present disclosure is not limited to such an aspect. For example, each head unit 3 may have a plurality of nozzle rows NL. In the present modification example as well, the same effect as the effect of the embodiment and modification examples described above can be obtained.

### Ninth Modification Example

Although it is assumed that the ink jet printer 1 includes four head units 3 in the embodiment and modification examples described above, the present disclosure is not limited to such an aspect. For example, the ink jet printer 1 may have one or more and three or less head units 3, or may have five or more head units 3. Alternatively, the ink jet printer 1 may have one or more head units 3A and three or less head units 3A, or may have five or more head units 3A.

### Tenth Modification Example

In the embodiment and the modification example described above, a case where the first filter circuit 344 is a multiplex feedback type band pass filter is described as an example, but the present disclosure is not limited to such an aspect. For example, as the first filter circuit 344, a filter circuit in which a group delay characteristics such as a Butterworth type and a Chebyshev type is changed may be used. In the present modification example as well, the same effect as the effect of the embodiment and modification examples described above can be obtained.

### 3. APPENDIXES

From the embodiments described above, for example, the following configuration can be ascertained.

According to Aspect 1 as a preferred aspect, there is provided a liquid ejecting apparatus including: a drive signal generation section that generates a drive signal; an ejecting section that includes a nozzle, a piezoelectric element driven by the drive signal, and a pressure chamber that ejects a liquid from the nozzle in response to driving of the piezoelectric element; a signal generation section to which a residual vibration signal generated by residual vibration in the ejecting section after the piezoelectric element is driven is input, and which generates a pseudo residual vibration signal according to the residual vibration signal; and a determination section that determines a state of the ejecting section based on the pseudo residual vibration signal, in which the signal generation section includes a filter circuit that generates the pseudo residual vibration signal, and the filter circuit includes a variable resistor section having an adjustable resistance value.

With Aspect 1, a length of the unit period, which is a cycle for driving the ejecting section can be reduced. Further, with Aspect 1, a characteristic of the pseudo residual vibration signal can be adjusted by adjusting the resistance value of the variable resistor section.

In the liquid ejecting apparatus according to Aspect 2 which is a specific example of Aspect 1, the filter circuit includes a variable capacitor having an adjustable capacitance value.

With Aspect 2, the characteristic of the pseudo residual vibration signal can be adjusted by adjusting the capacitance value of the variable capacitor.

In the liquid ejecting apparatus according to Aspect 3 which is a specific example of Aspect 1, the filter circuit further includes a differential amplifier that includes a first input terminal and a second input terminal to which a reference potential is supplied, a first resistor of which one end is supplied with the residual vibration signal and the other end is electrically coupled to a first node, a second resistor of which one end is coupled to the first input terminal and the other end is electrically coupled to an output terminal of the differential amplifier, a first capacitor of which one end is electrically coupled to the first node and the other end is coupled to the first input terminal, and a second capacitor of which one end is electrically coupled to the first node and the other end is electrically coupled to the output terminal of the differential amplifier, one end of the variable resistor section is electrically coupled to the first node and the other end of the variable resistor section is supplied with the reference potential, and at least one of the first capacitor and the second capacitor is a variable capacitor having an adjustable capacitance value.

With Aspect 3, the pseudo residual vibration signal having one cycle or more can be generated based on the residual vibration signal having less than one cycle. Further, with Aspect 3, the filter circuit for generating the pseudo residual vibration signal can be configured with a simple circuit.

In the liquid ejecting apparatus according to Aspect 4 which is a specific example of Aspect 3, a resistance value of the first resistor is equal to a resistance value of the second resistor.

With Aspect 4, a design of the filter circuit that generates the pseudo residual vibration signal, the adjustment of an amplitude of the pseudo residual vibration signal, and the like can be prevented from being complicated.

In the liquid ejecting apparatus according to Aspect 5 which is a specific example of Aspect 3 or 4, both the first capacitor and the second capacitor are variable capacitors having an adjustable capacitance value, and the capacitance value of the first capacitor after adjustment is equal to the capacitance value of the second capacitor after adjustment.

With Aspect 5, the design of the filter circuit that generates the pseudo residual vibration signal, the adjustment of the cycle of the pseudo residual vibration signal, and the like can be prevented from being complicated.

In the liquid ejecting apparatus according to Aspect 6 which is a specific example of any one of Aspects 2 to 5, a cycle of the pseudo residual vibration signal is changed by adjusting the capacitance value of the variable capacitor.

With Aspect 6, the cycle of the pseudo residual vibration signal generated by the filter circuit can be adjusted by adjusting the capacitance value of the variable capacitor.

In the liquid ejecting apparatus according to Aspect 7 which is a specific example of any one of Aspects 1 to 6, an amplitude of the pseudo residual vibration signal is changed by adjusting the resistance value of the variable resistor section.

With Aspect 7, the cycle of the pseudo residual vibration signal generated by the filter circuit can be adjusted by adjusting the resistance value of the variable resistor section.

In the liquid ejecting apparatus according to Aspect 8 which is a specific example of any one of Aspects 1 to 7, a cycle of the residual vibration signal input to the filter circuit is ¼ cycle or more and less than one cycle, and a cycle of the pseudo residual vibration signal output from the filter circuit is equal to or more than one cycle.

With Aspect 8, the state of the ejecting section can be accurately determined while a length of a unit period is reduced.

In the liquid ejecting apparatus according to Aspect 9 which is a specific example of any one of Aspects 1 to 8, the signal generation section includes a low-pass filter, and the residual vibration signal is input to the filter circuit via the low-pass filter.

According to Aspect 9, occurrence of a distortion in the pseudo residual vibration signal can be suppressed.

The liquid ejecting apparatus according to Aspect 10 which is a specific example of any one of Aspects 1 to 9, the determination section determines a thickened state of the liquid in the ejecting section.

With Aspect 10, an increase in time required for determining the thickened state of the liquid in the ejecting section can be suppressed.

In addition, according to Aspect 11 as a preferred aspect, there is provided a liquid ejecting head including: an ejecting section that includes a nozzle, a piezoelectric element driven by a drive signal, and a pressure chamber that ejects a liquid from the nozzle in response to driving of the piezoelectric element; and a signal generation section to which a residual vibration signal generated by residual vibration in the ejecting section after the piezoelectric element is driven is input, and which generates a pseudo residual vibration signal according to the residual vibration signal, as a signal for determining a state of the ejecting section; and a determination section that determines a state of the ejecting section based on the pseudo residual vibration signal, in which the signal generation section includes a filter circuit that generates the pseudo residual vibration signal, and the filter circuit includes a variable resistor section having an adjustable resistance value.

With Aspect 11, the same effect as the effect of Aspect 1 can be obtained.

In the liquid ejecting head according to Aspect 12 which is a specific example of Aspect 11, the filter circuit includes a variable capacitor having an adjustable capacitance value.

With Aspect 12, the same effect as the effect of Aspect 2 can be obtained.

In the liquid ejecting head according to Aspect 13 which is a specific example of Aspect 11, the filter circuit further includes a differential amplifier that includes a first input terminal and a second input terminal to which a reference potential is supplied, a first resistor of which one end is supplied with the residual vibration signal and the other end is electrically coupled to a first node, a second resistor of which one end is coupled to the first input terminal and the other end is electrically coupled to an output terminal of the differential amplifier, a first capacitor of which one end is electrically coupled to the first node and the other end is coupled to the first input terminal, and a second capacitor of which one end is electrically coupled to the first node and the other end is electrically coupled to the output terminal of the differential amplifier, one end of the variable resistor section is electrically coupled to the first node and the other end of the variable resistor section is supplied with the reference potential, and at least one of the first capacitor and the second capacitor is a variable capacitor having an adjustable capacitance value.

With Aspect 13, the same effect as the effect of Aspect 3 can be obtained.

In the liquid ejecting head according to Aspect 14 which is a specific example of Aspect 13, a resistance value of the first resistor is equal to a resistance value of the second resistor.

With Aspect 14, the same effect as the effect of Aspect 4 can be obtained.

In the liquid ejecting head according to Aspect 15 which is a specific example of Aspect 13 or 14, both the first capacitor and the second capacitor are variable capacitors having an adjustable capacitance value, and the capacitance value of the first capacitor after adjustment is equal to the capacitance value of the second capacitor after adjustment.

With Aspect 15, the same effect as the effect of Aspect 5 can be obtained.

In the liquid ejecting head according to Aspect 16 which is a specific example of any one of Aspects 12 to 15, a cycle of the pseudo residual vibration signal is changed by adjusting the capacitance value of the variable capacitor.

With Aspect 16, the same effect as the effect of Aspect 6 can be obtained.

In the liquid ejecting head according to Aspect 17 which is a specific example of any one of Aspects 11 to 16, an amplitude of the pseudo residual vibration signal is changed by adjusting the resistance value of the variable resistor section.

With Aspect 17, the same effect as the effect of Aspect 7 can be obtained.

In the liquid ejecting head according to Aspect 18 which is a specific example of any one of Aspects 11 to 17, a cycle of the residual vibration signal input to the filter circuit is ¼ cycle or more and less than one cycle, and a cycle of the pseudo residual vibration signal output from the filter circuit is equal to or more than one cycle.

With Aspect 18, the same effect as the effect of Aspect 8 can be obtained.

In the liquid ejecting head according to Aspect 19 which is a specific example of any one of Aspects 11 to 18, the signal generation section includes a low-pass filter, and the residual vibration signal is input to the filter circuit via the low-pass filter.

With Aspect 19, the same effect as the effect of Aspect 9 can be obtained.

In the liquid ejecting head according to Aspect 20 which is a specific example of any one of Aspects 11 to 19, the pseudo residual vibration signal is used to determine a thickened state of the liquid in the ejecting section.

With Aspect 20, the same effect as the effect of Aspect 10 can be obtained.

What is claimed is:

1. A liquid ejecting apparatus comprising:
a drive signal generation section that generates a drive signal;
an ejecting section that includes a nozzle, a piezoelectric element driven by the drive signal, and a pressure chamber that ejects a liquid from the nozzle in response to driving of the piezoelectric element;
a signal generation section to which a residual vibration signal generated by residual vibration in the ejecting section after the piezoelectric element is driven is input, and which generates a pseudo residual vibration signal according to the residual vibration signal; and
a determination section that determines a state of the ejecting section based on the pseudo residual vibration signal, wherein
the signal generation section includes a filter circuit that generates the pseudo residual vibration signal, and
the filter circuit includes a variable resistor section having an adjustable resistance value.

2. The liquid ejecting apparatus according to claim 1, wherein
the filter circuit includes a variable capacitor having an adjustable capacitance value.

3. The liquid ejecting apparatus according to claim 1, wherein
the filter circuit further includes
a differential amplifier that includes a first input terminal and a second input terminal to which a reference potential is supplied,
a first resistor of which one end is supplied with the residual vibration signal and the other end is electrically coupled to a first node,
a second resistor of which one end is coupled to the first input terminal and the other end is electrically coupled to an output terminal of the differential amplifier,
a first capacitor of which one end is coupled to the first node and the other end is electrically coupled to the first input terminal, and
a second capacitor of which one end is electrically coupled to the first node and the other end is electrically coupled to the output terminal of the differential amplifier,
one end of the variable resistor section is electrically coupled to the first node and the other end of the variable resistor section is supplied with the reference potential, and
at least one of the first capacitor and the second capacitor is a variable capacitor having an adjustable capacitance value.

4. The liquid ejecting apparatus according to claim 3, wherein
a resistance value of the first resistor is equal to a resistance value of the second resistor.

5. The liquid ejecting apparatus according to claim 3, wherein
both the first capacitor and the second capacitor are variable capacitors having an adjustable capacitance value, and
the capacitance value of the first capacitor after adjustment is equal to the capacitance value of the second capacitor after adjustment.

6. The liquid ejecting apparatus according to claim 2, wherein
a cycle of the pseudo residual vibration signal is changed by adjusting the capacitance value of the variable capacitor.

7. The liquid ejecting apparatus according to claim 1, wherein
an amplitude of the pseudo residual vibration signal is changed by adjusting the resistance value of the variable resistor section.

8. The liquid ejecting apparatus according to claim 1, wherein
a cycle of the residual vibration signal input to the filter circuit is ¼ cycle or more and less than one cycle, and
a cycle of the pseudo residual vibration signal output from the filter circuit is equal to or more than one cycle.

9. The liquid ejecting apparatus according to claim 1, wherein
the signal generation section includes a low-pass filter, and
the residual vibration signal is input to the filter circuit via the low-pass filter.

10. The liquid ejecting apparatus according to claim 1, wherein
the determination section determines a thickened state of the liquid in the ejecting section.

11. A liquid ejecting head comprising:
an ejecting section that includes a nozzle, a piezoelectric element driven by a drive signal, and a pressure chamber that ejects a liquid from the nozzle in response to driving of the piezoelectric element; and
a signal generation section to which a residual vibration signal generated by residual vibration in the ejecting section after the piezoelectric element is driven is input, and which generates a pseudo residual vibration signal according to the residual vibration signal, as a signal for determining a state of the ejecting section, wherein
the signal generation section includes a filter circuit that generates the pseudo residual vibration signal, and
the filter circuit includes a variable resistor section having an adjustable resistance value.

12. The liquid ejecting head according to claim 11, wherein
the filter circuit includes a variable capacitor having an adjustable capacitance value.

13. The liquid ejecting head according to claim 11, wherein
the filter circuit further includes
a differential amplifier that includes a first input terminal and a second input terminal to which a reference potential is supplied,
a first resistor of which one end is supplied with the residual vibration signal and the other end is electrically coupled to a first node,
a second resistor of which one end is coupled to the first input terminal and the other end is electrically coupled to an output terminal of the differential amplifier,
a first capacitor of which one end is coupled to the first node and the other end is electrically coupled to the first input terminal, and
a second capacitor of which one end is electrically coupled to the first node and the other end is electrically coupled to the output terminal of the differential amplifier,
one end of the variable resistor section is electrically coupled to the first node and the other end of the variable resistor section is supplied with the reference potential, and
at least one of the first capacitor and the second capacitor is a variable capacitor having an adjustable capacitance value.

14. The liquid ejecting head according to claim 13, wherein
a resistance value of the first resistor is equal to a resistance value of the second resistor.

15. The liquid ejecting head according to claim 13, wherein
both the first capacitor and the second capacitor are variable capacitors having an adjustable capacitance value, and
the capacitance value of the first capacitor after adjustment is equal to the capacitance value of the second capacitor after adjustment.

16. The liquid ejecting head according to claim 12, wherein
a cycle of the pseudo residual vibration signal is changed by adjusting the capacitance value of the variable capacitor.

17. The liquid ejecting head according to claim 11, wherein
an amplitude of the pseudo residual vibration signal is changed by adjusting the resistance value of the variable resistor section.

18. The liquid ejecting head according to claim 11, wherein
a cycle of the residual vibration signal input to the filter circuit is ¼ cycle or more and less than one cycle, and
a cycle of the pseudo residual vibration signal output from the filter circuit is equal to or more than one cycle.

19. The liquid ejecting head according to claim 11, wherein
the signal generation section includes a low-pass filter, and
the residual vibration signal is input to the filter circuit via the low-pass filter.

20. The liquid ejecting head according to of claim 11, wherein
the pseudo residual vibration signal is used to determine a thickened state of the liquid in the ejecting section.
